(19) United States
(12) Patent Application Publication
(10) Pub. No.: US 2025/0380055 A1
(43) Pub. Date: Dec. 11, 2025

(54) SOLID-STATE IMAGING ELEMENT, IMAGING DEVICE, AND METHOD OF CONTROLLING SOLID-STATE IMAGING ELEMENT

(71) Applicant: SONY SEMICONDUCTOR SOLUTIONS CORPORATION, KANAGAWA (JP)

(72) Inventor: AKIMIRU YOSHIDA, KANAGAWA (JP)

(21) Appl. No.: 18/876,850

(22) PCT Filed: May 8, 2023
(86) PCT No.: PCT/JP2023/017239

§ 371 Date: Dec. 19, 2024

(30) Foreign Application Priority Data
Jun. 29, 2022 (JP) 2022-104116

(51) Int. Cl. H04N 23/667; H04N 23/67; H04N 25/50; H04N 25/778

(52) U.S. Cl. CPC H04N 23/667; H04N 23/67; H04N 25/50; H04N 25/778

(57) ABSTRACT

To simplify a configuration of an imaging device that does not require manual operation at the time of imaging.

A pixel includes a pre-stage circuit that sequentially generates a predetermined number of pixel signals and a pair of capacitive elements. A scanning circuit causes the pair of capacitive elements to hold respective signal levels of a pair of pixel signals among the predetermined number of pixel signals in a case where a sensing mode is set, and causes the pair of capacitive elements to hold a reset level and a signal level of any of the predetermined number of pixel signals in a case where the sensing mode is switched to a normal imaging mode. A difference calculation circuit calculates a difference between the respective signal levels of the pair of pixel signals in a case where the sensing mode is set. A mode control section determines whether or not to switch from the sensing mode to the normal imaging mode on the basis of the difference.

### TECHNICAL FIELD

The present technology relates to a solid-state imaging element. Specifically, the present technology relates to a solid-state imaging element that performs automatic imaging, an imaging device, and a method of controlling a solid-state imaging element.

### BACKGROUND ART

Conventionally, an automatic imaging mode that does not require a manual operation at the time of imaging has been used in a life log camera, a monitoring camera, and the like. For example, an imaging device that recognizes a voice command of a user and performs imaging according to the command has been proposed (See, for example, Patent Document 1.).

### CITATION LIST

### Patent Document

Patent Document 1: Japanese Patent Application Laid-Open No. 2019-106694

### SUMMARY OF THE INVENTION

### Problems to be Solved by the Invention

In the above-described conventional technique, imaging according to a user's instruction is enabled by performing imaging according to a voice command. However, in the above-described imaging device, a microphone for inputting voice and a circuit for performing voice recognition are required, and the configuration of the imaging device becomes complicated.

The present technology has been made in view of such a situation, and an object thereof is to simplify the configuration of an imaging device that does not require manual operation at the time of imaging.

### Solutions to Problems

The present technology has been made to solve the above-described problems, and a first aspect thereof is a solid-state imaging element including: a pixel including a pre-stage circuit that sequentially generates a predetermined number of pixel signals and a pair of capacitive elements; a scanning circuit that causes the pair of capacitive elements to hold respective signal levels of a pair of pixel signals among the predetermined number of pixel signals in a case where a sensing mode is set, and causes the pair of capacitive elements to hold a reset level and a signal level of any of the predetermined number of pixel signals in a case where the sensing mode is switched to a normal imaging mode; a difference calculation circuit that calculates a difference between the respective signal levels of the pair of pixel signals in a case where the sensing mode is set; and a mode control section that determines whether or not to switch from the sensing mode to the normal imaging mode on the basis of the difference, and a control method thereof. This brings about an effect of simplifying the configuration of the solid-state imaging element.

Furthermore, in the first aspect, the mode control section may determine whether or not to switch from the sensing mode to the normal imaging mode on the basis of a comparison result between an absolute value of the difference and a predetermined threshold. This brings about an effect that the mode is switched depending on the presence or absence of movement of a subject.

Furthermore, in the first aspect, the solid-state imaging element may further include a focus control section that detects an in-focus position of a lens and moves the lens to the in-focus position, the difference calculation circuit may calculate a difference between a signal level before the lens moves to the in-focus position and a signal level when the lens has moved to the in-focus position, and the mode control section may determine whether or not to switch from the sensing mode to the normal imaging mode on the basis of a comparison result between an absolute value of the difference and a predetermined threshold when the lens has moved to the in-focus position. This brings about an effect that focused image data is captured.

Furthermore, in the first aspect, the pre-stage circuit may include: a photoelectric conversion element; a transfer transistor that transfers a charge from the photoelectric conversion element to a floating diffusion layer; and a pre-stage amplification transistor that amplifies a voltage of the floating diffusion layer. This brings about an effect that a signal obtained by amplifying the voltage of the floating diffusion layer is read out.

Furthermore, in the first aspect, the scanning circuit may cause one of the pair of capacitive elements to hold a first signal level at an end of odd-numbered exposure and cause another of the pair of capacitive elements to hold a second signal level at an end of even-numbered exposure in a case where the sensing mode is set, and may cause the pair of capacitive elements to hold a reset level and a signal level at an end of exposure in a case of being switched to the normal imaging mode. This brings about an effect that the mode is switched on the basis of the difference between the signal levels.

Furthermore, in the first aspect, the scanning circuit may cause one of the pair of capacitive elements to hold a first signal level at an end of odd-numbered exposure and cause another of the pair of capacitive elements to hold a second signal level at an end of even-numbered exposure in a case where the sensing mode is set, and may cause one of the pair of capacitive elements to hold a reset level at an end of exposure in a case of being switched to the normal imaging mode. This brings about an effect of improving the frame rate.

Furthermore, in the first aspect, the pre-stage circuit may include: first and second photoelectric conversion elements; a first transfer transistor that transfers a charge from the first photoelectric conversion element to a floating diffusion layer; a second transfer transistor that transfers a charge from the second photoelectric conversion element to the floating diffusion layer; and a pre-stage amplification transistor that amplifies a voltage of the floating diffusion layer, and the first and second photoelectric conversion elements may have exposure periods partially overlapping with each other. This brings about an effect of improving the frame rate.

Furthermore, in the first aspect, the scanning circuit may cause one of the pair of capacitive elements to hold a first signal level according to an exposure amount of the first photoelectric conversion element and cause another of the pair of capacitive elements to hold a second signal level according to an exposure amount of the second photoelectric conversion element in a case where the sensing mode is set, and may cause the pair of capacitive elements to hold a reset level and a signal level at an end of exposure in a case of being switched to the normal imaging mode. This brings about an effect that the mode is switched on the basis of the difference between the signal levels.

Furthermore, in the first aspect, the pre-stage circuit may include: a photoelectric conversion element; a first transfer transistor that transfers a charge from the photoelectric conversion element to one of the pair of capacitive elements; a second transfer transistor that transfers a charge from the photoelectric conversion element to another of the pair of capacitive elements; and a discharge transistor that discharges a charge from the photoelectric conversion element. This brings about an effect that charges are transferred to each of the pair of capacitive elements by different transistors.

Furthermore, in the first aspect, the pixel may further include: a selection circuit that sequentially performs control to connect one of the pair of capacitive elements to a predetermined post-stage node, control to disconnect both the pair of capacitive elements from the post-stage node, and control to connect another of the pair of capacitive elements to the post-stage node; a post-stage reset transistor that initializes a level of the post-stage node when both the pair of capacitive elements are disconnected from the post-stage node; and a post-stage circuit that reads the pixel signals from the pair of capacitive elements via the post-stage node and outputs the pixel signals. This brings about an effect of reducing noise.

Furthermore, a second aspect of the present technology is an imaging device including: a pixel including a pre-stage circuit that sequentially generates a predetermined number of pixel signals and a pair of capacitive elements; a scanning circuit that causes the pair of capacitive elements to hold respective signal levels of a pair of pixel signals among the predetermined number of pixel signals in a case where a sensing mode is set, and causes the pair of capacitive elements to hold a reset level and a signal level of any of the predetermined number of pixel signals in a case where the sensing mode is switched to a normal imaging mode; a difference calculation circuit that calculates a difference between the respective signal levels of the pair of pixel signals in a case where the sensing mode is set; a mode control section that determines whether or not to switch from the sensing mode to the normal imaging mode on the basis of the difference; and an image data processing section that processes image data in which differences between the reset level and the signal level are arranged in a case of being switched to the normal imaging mode. This brings about an effect that the configuration of the imaging device is simplified.

### BRIEF DESCRIPTION OF DRAWINGS

FIG. 1 is a block diagram illustrating a configuration example of an imaging device in a first embodiment of the present technology.

FIG. 2 is a block diagram illustrating a configuration example of a solid-state imaging element according to the first embodiment of the present technology.

FIG. 3 is a circuit diagram illustrating a configuration example of a pixel according to the first embodiment of the present technology.

FIG. 4 is a circuit diagram illustrating another example of a pixel according to the first embodiment of the present technology.

FIG. 5 is a block diagram illustrating a configuration example of a load metal oxide semiconductor (MOS) circuit block and a column signal processing section according to the first embodiment of the present technology.

FIG. 6 is a block diagram illustrating a configuration example of a digital signal processing section in the first embodiment of the present technology.

FIG. 7 is a diagram for explaining an operation of a difference calculation circuit according to the first embodiment of the present technology.

FIG. 8 is a diagram illustrating an example of a state transition diagram of the solid-state imaging element according to the first embodiment of the present technology.

FIG. 9 is a timing chart illustrating an example of a first global shutter operation when a sensing mode is set according to the first embodiment of the present technology.

FIG. 10 is a timing chart illustrating an example of a second global shutter operation when the sensing mode is set according to the first embodiment of the present technology.

FIG. 11 is a timing chart illustrating an example of a reading operation when the sensing mode is set according to the first embodiment of the present technology.

FIG. 12 is a timing chart illustrating an example of a global shutter operation when a normal imaging mode is set according to the first embodiment of the present technology.

FIG. 13 is a timing chart illustrating an example of a reading operation when the normal imaging mode is set according to the first embodiment of the present technology.

FIG. 14 is a diagram illustrating an example of a waveform of a ramp signal according to the first embodiment of the present technology.

FIG. 15 is a diagram illustrating an example of an operation of the solid-state imaging element according to the first embodiment of the present technology.

FIG. 16 is an example of an overall view of the solid-state imaging element according to the first embodiment of the present technology.

FIG. 17 is an example of an overall view of a solid-state imaging element in a first modification of the first embodiment of the present technology.

FIG. 18 is a circuit diagram illustrating a configuration example of a pixel in a second modification of the first embodiment of the present technology.

FIG. 19 is a circuit diagram illustrating a configuration example of a pixel in a third modification of the first embodiment of the present technology.

FIG. 20 is a timing chart illustrating an example of a reading operation when the mode is switched to the normal imaging mode according to a second embodiment of the present technology.

FIG. 21 is a diagram for explaining an operation of a difference calculation circuit according to the second embodiment of the present technology.

FIG. 22 is a circuit diagram illustrating a configuration example of two pixels according to a third embodiment of the present technology.

FIG. 23 is a timing chart illustrating an example of a global shutter operation when the sensing mode is set according to the third embodiment of the present technology.

FIG. 24 is a timing chart illustrating an example of a global shutter operation when the mode is switched to the normal imaging mode according to the third embodiment of the present technology.

FIG. 25 is a timing chart illustrating an example of a global shutter operation according to a fourth embodiment of the present technology.

FIG. 26 is a timing chart illustrating an example of a reading operation according to the fourth embodiment of the present technology.

FIG. 27 is a timing chart illustrating another example of the reading operation according to the fourth embodiment of the present technology.

FIG. 28 is a circuit diagram illustrating a configuration example of a pixel in a first modification of the fourth embodiment of the present technology.

FIG. 29 is a timing chart illustrating an example of a global shutter operation in the first modification of the fourth embodiment of the present technology.

FIG. 30 is a timing chart illustrating an example of a reading operation in the first modification of the fourth embodiment of the present technology.

FIG. 31 is a diagram illustrating an example of a stacked structure of a solid-state imaging element in a second modification of the fourth embodiment of the present technology.

FIG. 32 is a circuit diagram illustrating a configuration example of a pixel in the second modification of the fourth embodiment of the present technology.

FIG. 33 is a diagram illustrating an example of a stacked structure of a solid-state imaging element in a third modification of the fourth embodiment of the present technology.

FIG. 34 is a circuit diagram illustrating a configuration example of a pixel according to a fifth embodiment of the present technology.

FIG. 35 is a timing chart illustrating an example of a global shutter operation according to the fifth embodiment of the present technology.

FIG. 36 is a circuit diagram illustrating a configuration example of a pixel according to a sixth embodiment of the present technology.

FIG. 37 is a diagram for explaining reset feedthrough in the sixth embodiment of the present technology.

FIG. 38 is a diagram for explaining variation in level due to the reset feedthrough in the sixth embodiment of the present technology.

FIG. 39 is a timing chart illustrating an example of voltage control according to the sixth embodiment of the present technology.

FIG. 40 is a timing chart illustrating an example of a global shutter operation of the odd-numbered frame according to a seventh embodiment of the present technology.

FIG. 41 is a timing chart illustrating an example of a reading operation for the odd-numbered frame according to the seventh embodiment of the present technology.

FIG. 42 is a timing chart illustrating an example of a global shutter operation for the even-numbered frame according to the seventh embodiment of the present technology.

FIG. 43 is a timing chart illustrating an example of a reading operation for the even-numbered frame according to the seventh embodiment of the present technology.

FIG. 44 is a timing chart illustrating an example of a rolling shutter operation according to an eighth embodiment of the present technology.

FIG. 45 is a block diagram illustrating a configuration example of a solid-state imaging element according to a ninth embodiment of the present technology.

FIG. 46 is a circuit diagram illustrating a configuration example of a dummy pixel, a regulator, and a switching section according to the ninth embodiment of the present technology.

FIG. 47 is a timing chart illustrating an example of an operation of the dummy pixel and the regulator according to the ninth embodiment of the present technology.

FIG. 48 is a circuit diagram illustrating a configuration example of an effective pixel according to the ninth embodiment of the present technology.

FIG. 49 is a timing chart illustrating an example of a global shutter operation according to the ninth embodiment of the present technology.

FIG. 50 is a timing chart illustrating an example of a reading operation according to the ninth embodiment of the present technology.

FIG. 51 is a diagram for explaining an effect in the ninth embodiment of the present technology.

FIG. 52 is a block diagram illustrating a schematic configuration example of a vehicle control system.

FIG. 53 is an explanatory diagram illustrating an example of an installation position of an imaging section.

### MODE FOR CARRYING OUT THE INVENTION

Hereinafter, modes for carrying out the present technology (hereinafter referred to as embodiments) will be described. The description will be given in the following order.
1. First embodiment (Example of switching mode on basis of difference in signal level)
2. Second embodiment (Example of switching mode on basis of difference in signal level and reading only reset level)
3. Third embodiment (Example in which floating diffusion layer is shared by two pixels and mode is switched on basis of difference in signal level)
4. Fourth embodiment (Example of changing method of driving pixel)
5. Fifth embodiment (Example of adding discharge transistor and causing first and second capacitive elements to hold pixel signals)
6. Sixth embodiment (Example of causing first and second capacitive elements to hold pixel signals and controlling reset power supply voltage)
7. Seventh embodiment (Example of causing first and second capacitive elements to hold pixel signals and exchanging levels to be held for each frame)
8. Eighth embodiment (Example of causing first and second capacitive elements to hold pixel signal and performing rolling shutter operation)
9. Ninth embodiment (Example of reducing noise and causing first and second capacitive elements to hold pixel signals)
10. Application example to moving body

### 1. First Embodiment

### [Configuration Example of Imaging Device]

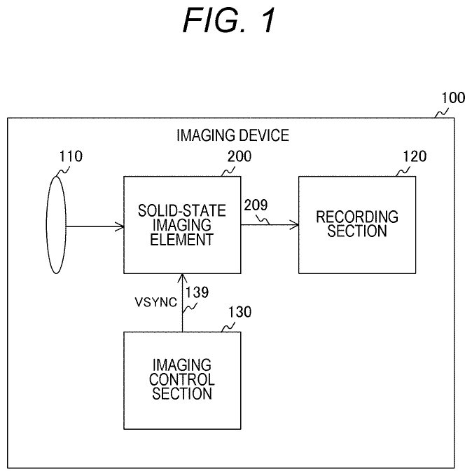

FIG. 1 is a block diagram illustrating a configuration example of an imaging device 100 according to a first embodiment of the present technology. The imaging device 100 is a device that captures image data, and includes an imaging lens 110, a solid-state imaging element 200, a recording section 120, and an imaging control section 130. As the imaging device 100, a digital camera, and an electronic device (a smartphone, a personal computer, or the like) having an imaging function are assumed.

The solid-state imaging element 200 captures the image data under control of the imaging control section 130. The solid-state imaging element 200 supplies the image data to the recording section 120 via a signal line 209.

The imaging lens 110 condenses light and guides the light to the solid-state imaging element 200. The imaging control section 130 controls the solid-state imaging element 200 to capture the image data. For example, the imaging control section 130 supplies an imaging control signal including a vertical synchronization signal VSYNC to the solid-state imaging element 200 via a signal line 139. The recording section 120 records the image data.

Here, the vertical synchronization signal VSYNC is a signal indicating imaging timing, and a periodic signal of a constant frequency (such as 60 hertz) is used as the vertical synchronization signal VSYNC.

Note that although the imaging device 100 records the image data, the image data may be transmitted to the outside of the imaging device 100. In this case, an external interface for transmitting the image data is further provided. Alternatively, the imaging device 100 may further display the image data. In this case, a display section is further provided.

### [Configuration Example of Solid-State Imaging Element]

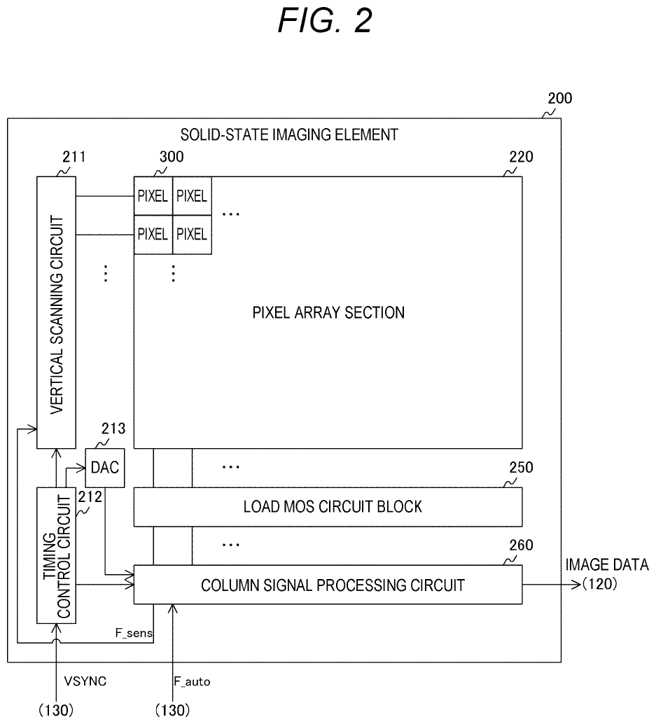

FIG. 2 is a block diagram illustrating a configuration example of the solid-state imaging element 200 according to the first embodiment of the present technology. The solid-state imaging element 200 includes a vertical scanning circuit 211, a pixel array section 220, a timing control circuit 212, a digital to analog converter (DAC) 213, a load MOS circuit block 250, and a column signal processing circuit 260. In the pixel array section 220, a plurality of pixels 300 is arranged in a two-dimensional grid pattern. Furthermore, each circuit in the solid-state imaging element 200 is provided in, for example, a single semiconductor chip.

Hereinafter, a set of pixels 300 arranged in a horizontal direction is referred to as “row”, and a set of pixels 300 arranged in a direction perpendicular to the row is referred to as “column”.

The timing control circuit 212 controls operation timing of each of the vertical scanning circuit 211, the DAC 213, and the column signal processing circuit 260 in synchronization with the vertical synchronization signal VSYNC from the imaging control section 130.

The DAC 213 generates a sawtooth wave-like ramp signal by digital to analog (DA) conversion. The DAC 213 supplies the generated ramp signal to the column signal processing circuit 260.

The vertical scanning circuit 211 sequentially selects and drives rows to output analog pixel signals. Each of the pixels 300 photoelectrically converts incident light to generate the analog pixel signal. This pixel 300 supplies the pixel signal to the column signal processing circuit 260 via the load MOS circuit block 250. Note that the vertical scanning circuit 211 is an example of a scanning circuit recited in the claims.

In the load MOS circuit block 250, a MOS transistor that supplies a constant current is provided for each column.

The column signal processing circuit 260 performs signal processing such as analog to digital (AD) conversion processing and correlated double sampling (CDS) processing on the pixel signal for each column. The column signal processing circuit 260 supplies the image data including the processed signals to the recording section 120.

### [Configuration Example of Pixel]

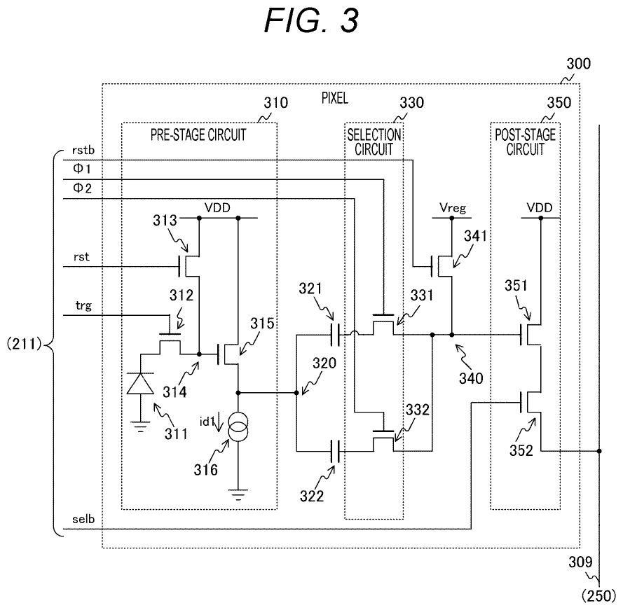

FIG. 3 is a circuit diagram illustrating a configuration example of the pixel 300 according to the first embodiment of the present technology. The pixel 300 includes a pre-stage circuit 310, capacitive elements 321 and 322, a selection circuit 330, a post-stage reset transistor 341, and a post-stage circuit 350.

The pre-stage circuit 310 includes a photoelectric conversion element 311, a transfer transistor 312, a floating diffusion (FD) reset transistor 313, an FD 314, a pre-stage amplification transistor 315, and a current source transistor 316.

The photoelectric conversion element 311 generates charges by the photoelectric conversion. The transfer transistor 312 transfers the charges from the photoelectric conversion element 311 to the FD 314 in accordance with a transfer signal trg from the vertical scanning circuit 211.

The FD reset transistor 313 extracts the charges from the FD 314 to initialize the FD 314 in accordance with an FD reset signal rst from the vertical scanning circuit 211. The FD 314 accumulates charges, and generates a voltage corresponding to a charge amount. The pre-stage amplification transistor 315 amplifies a level of a voltage of the FD 314, and outputs the amplified voltage to a pre-stage node 320.

Furthermore, the FD reset transistor 313 and the pre-stage amplification transistor 315 have their respective sources connected to a power supply voltage VDD. The current source transistor 316 is connected to a drain of the pre-stage amplification transistor 315. The current source transistor 316 supplies a current id1 under the control of the vertical scanning circuit 211.

The capacitive elements 321 and 322 have their respective one ends commonly connected to the pre-stage node 320 and have their respective other ends connected to the selection circuit 330. Note that the capacitive elements 321 and 322 are an example of a pair of capacitive elements recited in the claims.

The selection circuit 330 includes a selection transistor 331 and a selection transistor 332. The selection transistor 331 opens and closes a path between the capacitive element 321 and a post-stage node 340 in accordance with a selection signal Φ1 from the vertical scanning circuit 211. The selection transistor 332 opens and closes a path between the capacitive element 322 and the post-stage node 340 in accordance with a selection signal Φ2 from the vertical scanning circuit 211.

The post-stage reset transistor 341 initializes a level of the post-stage node 340 to a predetermined potential Vreg in accordance with a post-stage reset signal rstb from the vertical scanning circuit 211. A potential different from the power supply voltage VDD (for example, a potential lower than VDD) is set as the potential Vreg.

The post-stage circuit 350 includes a post-stage amplification transistor 351, and a post-stage selection transistor 352. The post-stage amplification transistor 351 amplifies the level of the post-stage node 340. The post-stage selection transistor 352 outputs a signal at the level amplified by the post-stage amplification transistor 351 to a vertical signal line 309 as a pixel signal in accordance with a post-stage selection signal selb from the vertical scanning circuit 211.

Note that, for example, n-channel metal oxide semiconductor (nMOS) transistors are used as various transistors (the transfer transistor 312 and the like) in the pixel 300.

The vertical scanning circuit 211 supplies the high-level FD reset signal rst and the transfer signal trg to all the pixels while setting the post-stage reset signal rstb to the high level at the start of exposure. Therefore, the photoelectric conversion element 311 is initialized. Hereinafter, this control is referred to as “PD reset”.

Then, the vertical scanning circuit 211 supplies the high-level FD reset signal rst over the pulse period for all the pixels immediately before the end of the exposure. Therefore, the FD 314 is initialized, and a level corresponding to the level of the FD 314 at that time is held in the capacitive element 321. This control is hereinafter referred to as “FD reset”.

The level of the FD 314 at the time of FD reset and a level corresponding to the level of the FD 314 (the level held in the capacitive element 321 and the level of the vertical signal line 309) are hereinafter collectively referred to as “P-phase” or “reset level”.

At the end of the exposure, the vertical scanning circuit 211 supplies the high-level transfer signal trg over the pulse period for all the pixels. Therefore, signal charges corresponding to an exposure amount are transferred to the FD 314, and a level corresponding to the level of the FD 314 at that time is held in the capacitive element 322.

The level of the FD 314 at the time of signal charge transfer and a level corresponding to the level of the FD 314 (the level held in the capacitive element 322 and the level of the vertical signal line 309) are hereinafter collectively referred to as “D-phase” or “signal level”.

The exposure control of simultaneously starting and ending the exposure for all the pixels in this manner is called a global shutter method. Under this exposure control, the pre-stage circuits 310 of all the pixels sequentially generate the reset level and the signal level. These levels are held in the capacitive elements 321 and 322. After the end of exposure, the vertical scanning circuit 211 sequentially selects a row and outputs a level (reset level or signal level) of the row.

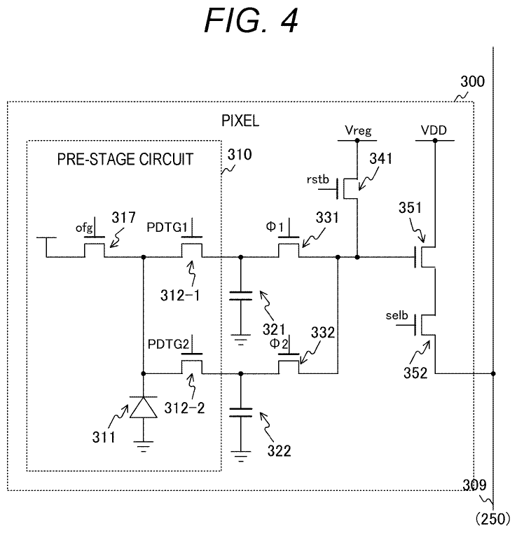

Note that the circuit configuration of the pixel 300 is not limited to that illustrated in the drawing as long as a plurality of levels (reset level and signal level) can be generated and held. For example, as illustrated in FIG. 4, transfer transistors 312-1 and 312-2 can be disposed instead of the transfer transistor 312. In this case, the FD reset transistor 313, the pre-stage amplification transistor 315, and the current source transistor 316 are not disposed, and a discharge transistor 317 is added.

The transfer transistor 312-1 transfers a charge from the photoelectric conversion element 311 to the capacitive element 321 in accordance with a transfer signal PDTG1 from the vertical scanning circuit 211. The transfer transistor 312-2 transfers a charge from the photoelectric conversion element 311 to the capacitive element 322 in accordance with a transfer signal PDTG2 from the vertical scanning circuit 211. The discharge transistor 317 functions as an overflow drain that discharges a charge from the photoelectric conversion element 311 in accordance with a discharge signal ofg from the vertical scanning circuit 211.

### [Configuration Example of Column Signal Processing Circuit]

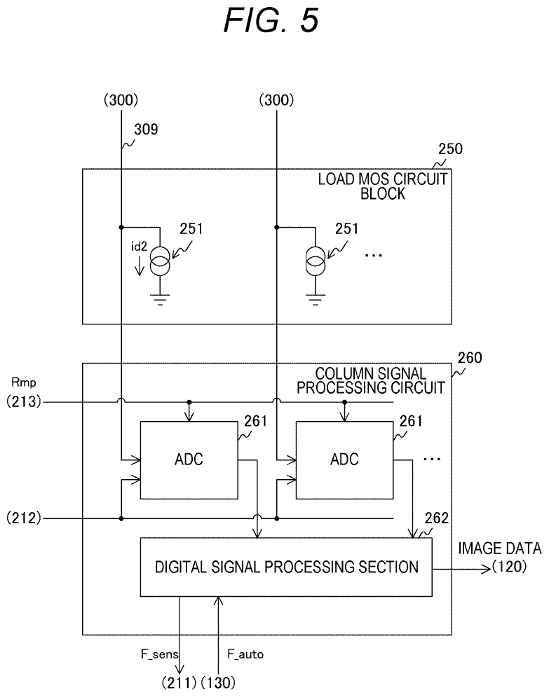

FIG. 5 is a block diagram illustrating a configuration example of the load MOS circuit block 250 and the column signal processing circuit 260 according to the first embodiment of the present technology.

In the load MOS circuit block 250, the vertical signal line 309 is wired for each column. In a case where the number of columns is I (I is an integer), I vertical signal lines 309 are wired. Furthermore, a load MOS transistor 251 that supplies a constant current id2 is connected to each of the vertical signal lines 309.

In the column signal processing circuit 260, a plurality of ADCs 261 and a digital signal processing section 262 are disposed. Each of the ADCs 261 is disposed for each column. In a case where the number of columns is I, I ADCs 261 are disposed.

The ADC 261 converts an analog pixel signal from the corresponding column into a digital signal using a ramp signal Rmp from the DAC 213. The ADC 261 supplies the digital signal to the digital signal processing section 262. For example, a single-slope ADC including a comparator and a counter is disposed as the ADC 261.

The digital signal processing section 262 performs predetermined signal processing such as CDS processing on the digital signal for each column. The digital signal processing section 262 supplies image data including the processed digital signals to the recording section 120.

Here, either a manual imaging mode or an automatic imaging mode is set in the solid-state imaging element 200 according to a user's operation or the like. The manual imaging mode is a mode in which the solid-state imaging element 200 performs imaging in accordance with a user's operation such as pressing of a shutter button. On the other hand, the automatic imaging mode is a mode that does not require a user operation at the time of imaging.

A flag F_auto instructing either the manual imaging mode or the automatic imaging mode is input to the digital signal processing section 262. Furthermore, the automated driving mode includes a sensing mode and a normal imaging mode, and when the automated driving mode is set, the digital signal processing section 262 shifts to the sensing mode.

The sensing mode is a mode in which the solid-state imaging element 200 detects the presence or absence of movement of the subject. On the other hand, the normal imaging mode is a mode in which the solid-state imaging element 200 generates image data. In a case where there is movement, the solid-state imaging element 200 switches from the sensing mode to the normal imaging mode and performs imaging. The digital signal processing section 262 generates a flag F_sense instructing either the sensing mode or the normal imaging mode, and supplies the flag F_sense to the vertical scanning circuit 211.

In a case where the manual imaging mode is set, the vertical scanning circuit 211 simultaneously exposes all the pixels, causes each of the pixels to generate a reset level and a signal level, and causes the capacitive elements 321 and 322 to hold the reset level and the signal level. Then, the vertical scanning circuit 211 sequentially selects a row after the exposure, and sequentially outputs the reset level and the signal level of each pixel in the row. The digital signal processing section 262 performs AD conversion and CDS processing to generate image data.

In a case where the mode is switched to the automated driving mode and the sensing mode is set, the vertical scanning circuit 211 performs control to simultaneously expose all the pixels a plurality of times.

At the end of the odd-numbered exposure, the vertical scanning circuit 211 causes each of the pixels to generate a signal level and causes one of the capacitive elements 321 and 322 to hold the signal level. At the end of the even-numbered exposure, the vertical scanning circuit 211 causes each of the pixels to generate a signal level and causes the other of the capacitive elements 321 and 322 to hold the signal level. Then, the vertical scanning circuit 211 sequentially selects rows after the even-numbered exposure and sequentially outputs a pair of signal levels of each pixel in the row.

Note that an amount of the odd-numbered exposure and an amount of the even-numbered exposure are controlled to be substantially the same. For example, in the solid-state imaging element 200, a diaphragm value and international organization for standardization (ISO) sensitivity are made substantially the same as an exposure time in each exposure.

In the sensing mode, the digital signal processing section 262 determines whether or not to switch to the normal imaging mode on the basis of a comparison result between an absolute value of a difference between a pair of signal levels and a predetermined threshold. For example, the digital signal processing section 262 determines that the subject moves in a case where there is one or more pixels in which the absolute value of the difference exceeds the threshold, and switches the sensing mode to the normal imaging mode.

In a case where the mode is switched to the normal imaging mode, the vertical scanning circuit 211 generates image data by the control similar to that in the manual imaging mode.

### [Configuration Example of Digital Signal Processing Section]

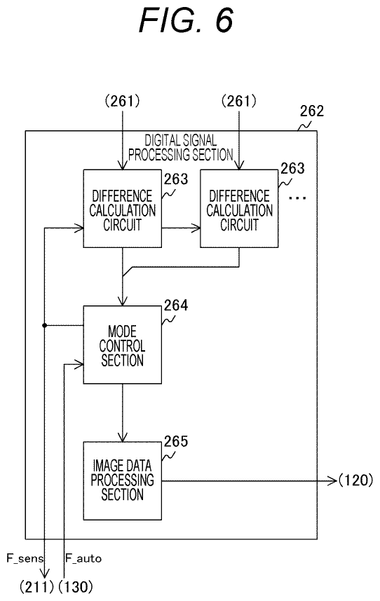

FIG. 6 is a block diagram illustrating a configuration example of the digital signal processing section 262 according to the first embodiment of the present technology. The digital signal processing section 262 includes a plurality of difference calculation circuits 263, a mode control section 264, and an image data processing section 265. Each of the difference calculation circuits 263 is provided for each column.

The difference calculation circuit 263 calculates a difference between the levels held in the capacitive elements 321 and 322 in the corresponding columns. In the manual imaging mode, the difference calculation circuit 263 performs CDS processing of calculating a difference between the signal level and the reset level after the AD conversion as a net signal level, and supplies a processing result to the mode control section 264.

In the sensing mode in the automatic imaging mode, the difference calculation circuit 263 calculates a difference between the pair of signal levels after the AD conversion and supplies the difference to the mode control section 264. In the normal imaging mode, the difference calculation circuit 263 performs CDS processing similar to that in the manual imaging mode, and supplies a processing result to the mode control section 264.

The mode control section 264 determines whether or not to switch from the sensing mode to the normal imaging mode on the basis of the difference in the sensing mode. For example, in a case where the absolute value of the difference exceeds the threshold in one or more pixels of all the pixels, the mode control section 264 determines that the subject moves and switches to the normal imaging mode.

At this time, for example, in a case where the threshold is 2P, the mode control section 264 can determine whether or not the absolute value of the difference exceeds the threshold by referring to the P-th digit of the code indicating the absolute value of the difference. Then, the mode control section 264 generates a flag F_sense designating the mode, and supplies the flag F_sense to the difference calculation circuit 263 and the vertical scanning circuit 211 of each column. In a case where the P-th digit of the code is referred to, for example, an OR gate that outputs an OR (logical product) of bits of the P-th digit of each column as F_sense is used as the mode control section 264.

Furthermore, the mode control section 264 supplies a CDS processing result to the image data processing section 265 as it is in the manual imaging mode or the normal imaging mode.

The image data processing section 265 performs various types of image processing on the image data in which the CDS processing results of the respective pixels are arranged, and supplies the processed image data to the recording section 120.

Note that the mode control section 264 determines the presence or absence of movement of the subject on the basis of whether or not the absolute value of the difference has exceeded the threshold in one or more of all the pixels, but the method of determining the presence or absence of movement is not limited to this method. For example, the mode control section 264 can also determine that there is movement in a case where a certain area is set as a monitoring target and the absolute value of the difference exceeds a threshold in one or more pixels in the area. Alternatively, the mode control section 264 can count the number of pixels of which the absolute value of the difference exceeds the threshold, and determine that there is movement in a case where the count value exceeds a certain value.

### [Operation Example of Solid-State Imaging Element]

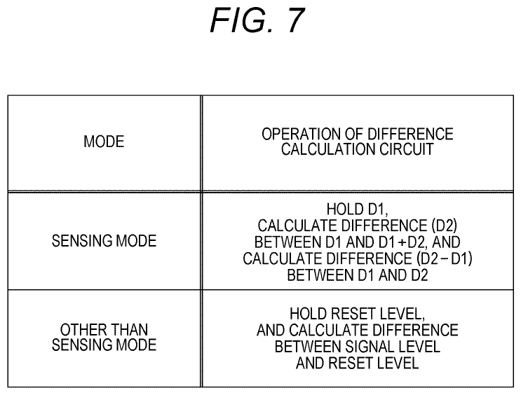

FIG. 7 is a diagram for explaining the operation of the difference calculation circuit 263 according to the first embodiment of the present technology. In the sensing mode, a signal level at the time of odd-numbered exposure is D1, and a signal level at the time of even-numbered exposure is D2. After the odd-numbered exposure, the signal level D1 is output from the pixel 300, and after the even-numbered exposure, the sum of the signal levels D1 and D2 is output from the pixel 300.

In the sensing mode, the difference calculation circuit 263 holds the signal level D1 in a memory or the like. Then, the difference calculation circuit 263 calculates D2 that is a difference between the sum of the signal levels D1 and D2 and the held signal level D1. The difference calculation circuit 263 calculates and outputs a difference between the signal level D2 and the held signal level D1.

In a mode other than the sensing mode (the manual imaging mode or the normal imaging mode), the difference calculation circuit 263 holds the reset level in a memory or the like. Then, the difference calculation circuit 263 calculates and outputs a difference between the signal level and the held reset level.

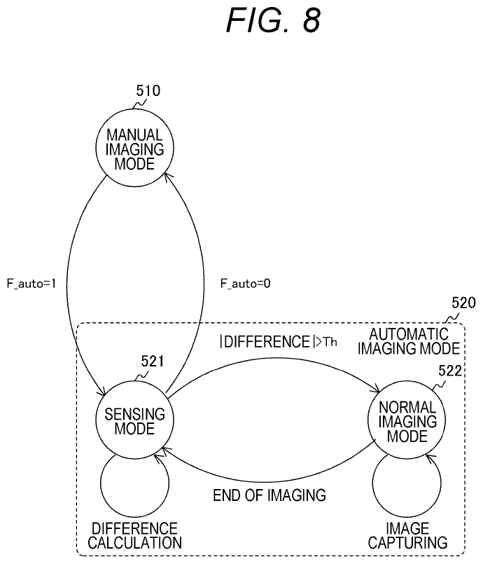

FIG. 8 is a diagram illustrating an example of a state transition diagram of the solid-state imaging element 200 according to the first embodiment of the present technology. In the initial state, for example, the manual imaging mode 510 is set.

In the manual imaging mode 510, when the flag F_auto is set to the high level, the mode is switched to the automatic imaging mode 520, and the sensing mode 521 is set.

In the sensing mode 521, when the flag F_auto is set to the low level, the mode is switched to the manual imaging mode 510.

Furthermore, in the sensing mode 521, the solid-state imaging element 200 calculates a difference between signal levels, and determines, for each pixel, whether or not the absolute value of the difference exceeds a threshold Th. In a case where the absolute value of the difference exceeds the threshold Th in one or more pixels, the sensing mode 521 is switched to the normal imaging mode 522.

In the normal imaging mode 522, the solid-state imaging element 200 captures image data. After the end of imaging, the normal imaging mode 522 is switched to the sensing mode 521.

### [Operation Example of Solid-State Imaging Element]

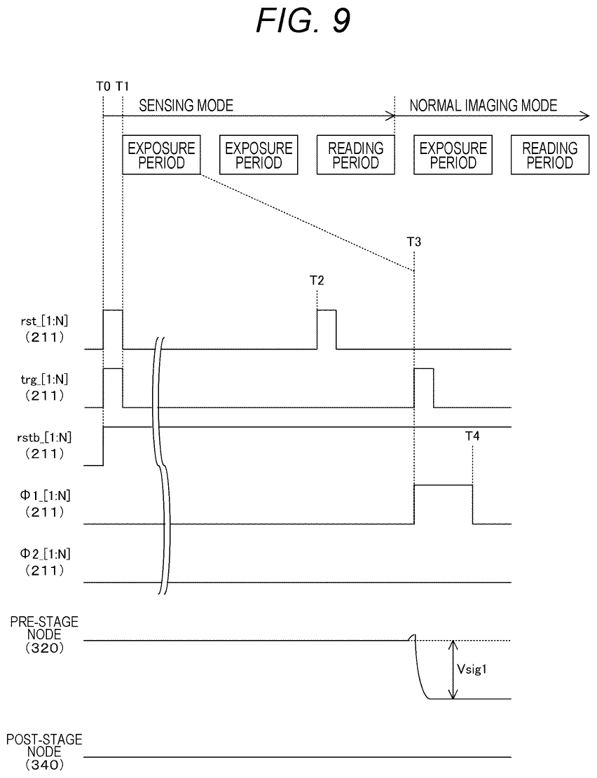

FIG. 9 is a timing chart illustrating an example of an odd-numbered global shutter operation when the sensing mode is set according to the first embodiment of the present technology.

In a case where the sensing mode is set, the solid-state imaging element 200 performs control to simultaneously expose all the pixels a plurality of times. A period from timing T1 to T3 in the drawing corresponds to an odd-numbered exposure period.

At timing TO immediately before the odd-numbered exposure period, the vertical scanning circuit 211 sets the post-stage reset signals rstb of all the rows (in other words, all pixels) to the high level. Furthermore, the vertical scanning circuit 211 supplies the high-level FD reset signal rst and transfer signal trg to all the pixels over a period from timing T0 to timing T1. Therefore, all the pixels are PD reset, and the exposure simultaneously starts in all the rows.

Here, rst_[n], trg_[n], and rstb_[n] in the drawing indicate signals to pixels in the nth row among the N rows. N is an integer indicating the total number of rows, and n is an integer from 1 to N.

Then, at timing T2 immediately before the end of the exposure period, the vertical scanning circuit 211 supplies the high-level FD reset signal rst over the pulse period. Therefore, all the pixels are FD reset.

At exposure end timing T3, the vertical scanning circuit 211 supplies the high-level transfer signal trg over the pulse period while setting the selection signal Φ1 to the high level in all the pixels. As a result, the signal level according to an amount of the odd-numbered exposure is sampled and held. Furthermore, the level of the pre-stage node 320 decreases from the reset level to the signal level. A difference therebetween corresponds to a net signal level Vsig1. Furthermore, Φ1_[n] in the drawing indicates a signal to a pixel in the nth row.

At timing T4 after timing T3, the vertical scanning circuit 211 returns the selection signal Φ1 to the low level.

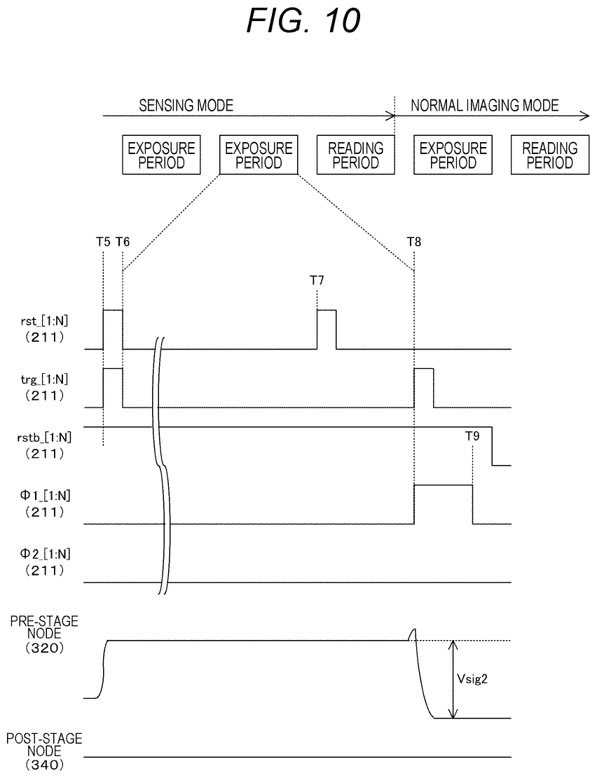

FIG. 10 is a timing chart illustrating an example of an even-numbered global shutter operation when the sensing mode is set according to the first embodiment of the present technology. A period from timing T6 to T8 in the drawing corresponds to an even-numbered exposure period.

The vertical scanning circuit 211 supplies the high-level FD reset signal rst and transfer signal trg to all the pixels over a period from timing T5 to timing T6. Therefore, all the pixels are PD reset, and the exposure simultaneously starts in all the rows.

Then, at timing T7 immediately before the end of the exposure period, the vertical scanning circuit 211 supplies the high-level FD reset signal rst over the pulse period. Therefore, all the pixels are FD reset.

At exposure end timing T8, the vertical scanning circuit 211 supplies the high-level transfer signal trg over the pulse period while setting the selection signal Φ1 to the high level in all the pixels. As a result, the signal level according to an amount of the even-numbered exposure is sampled and held. Furthermore, the level of the pre-stage node 320 decreases from the reset level to the signal level. A difference therebetween corresponds to a net signal level Vsig2. Furthermore, Φ2_[n] in the drawing indicates a signal to a pixel in the nth row.

At timing T9 after timing T8, the vertical scanning circuit 211 returns the selection signal Φ2 to the low level.

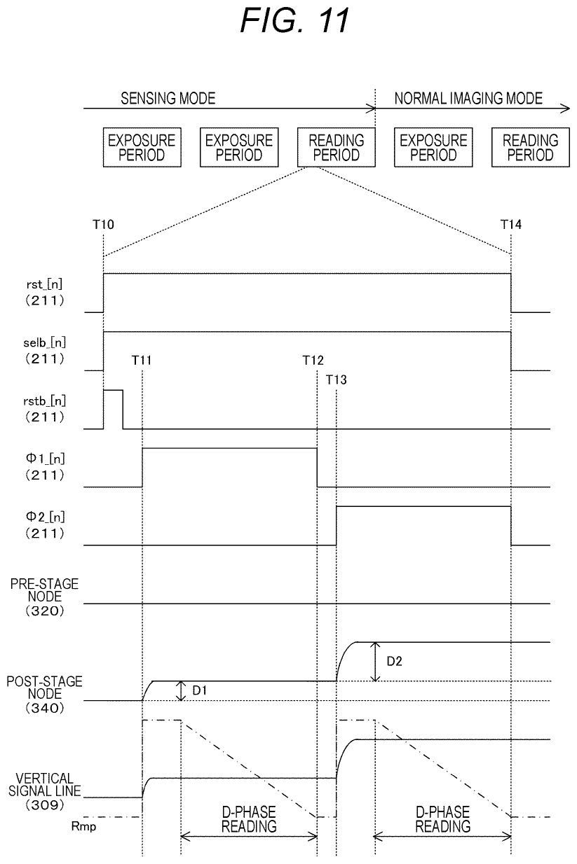

FIG. 11 is a timing chart illustrating an example of a reading operation when the sensing mode is set according to the first embodiment of the present technology. Immediately after the even-numbered exposure, the rows are sequentially selected, and the signal level of each row is read. T10 to T14 in the drawing denote a reading operation of the nth row.

In the reading period of the nth row from timing T10 to timing T14, the vertical scanning circuit 211 sets the FD reset signal rst and the post-stage selection signal selb of the nth row to the high level. Here, selb_[n] in the drawing indicates signals to pixels in the n-th row.

From timing T10 to the pulse period, the vertical scanning circuit 211 supplies the high-level post-stage reset signal rstb to the nth row. As a result, the post-stage node 340 is initialized.

The vertical scanning circuit 211 supplies a high-level selection signal Φ1 to the nth row over a period from timing T11 immediately after timing T10 to timing T12. A potential of the post-stage node 340 increases by a signal level according to the amount of the odd-numbered exposure. The odd-numbered signal level is defined as D1.

The DAC 213 gradually decreases the ramp signal Rmp over a period from immediately after timing T11 to timing T12. The ADC 261 compares the ramp signal Rmp with the level of the vertical signal line 309, and counts a count value until the comparison result is inverted. As a result, the signal level D1 is read.

Then, the vertical scanning circuit 211 supplies a high-level selection signal Φ2 to the nth row over a period from timing T13 immediately after timing T12 to timing T14. The potential of the post-stage node 340 increases by a signal level according to the amount of the even-numbered exposure. The odd-numbered signal level is defined as D2.

The DAC 213 gradually decreases the ramp signal Rmp over a period from immediately after timing T13 to timing T14. The ADC 261 compares the ramp signal Rmp with the level of the vertical signal line 309, and counts a count value until the comparison result is inverted. As a result, the sum of the signal levels D1 and D2 is read.

The mode control section 264 determines the presence or absence of movement of the subject on the basis of a difference between the signal levels D1 and D2 of each pixel, and switches from the sensing mode to the normal imaging mode in a case where there is movement.

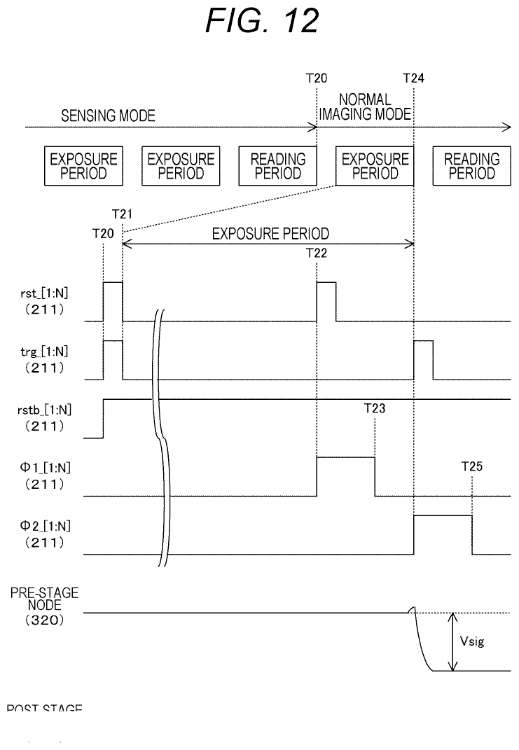

FIG. 12 is a timing chart illustrating an example of a global shutter operation when the normal imaging mode is set according to the first embodiment of the present technology. It is assumed that the imaging mode is switched to the normal imaging mode at timing T20.

At timing T20, the vertical scanning circuit 211 sets the post-stage reset signal rstb of all the pixels to the high level. Furthermore, the vertical scanning circuit 211 supplies the high-level FD reset signal rst and transfer signal trg to all the pixels over a period from timing T20 to timing T21. Therefore, all the pixels are PD reset, and the exposure simultaneously starts in all the rows.

At timing T22 immediately before the end of the exposure, the vertical scanning circuit 211 supplies the high-level FD reset signal rst over the pulse period while setting the selection signal Φ1 to the high level in all the pixels. Therefore, all the pixels are FD reset, and the reset level is sampled and held. At timing T23 after timing T22, the vertical scanning circuit 211 returns the selection signal Φ1 to the low level.

At exposure end timing T24, the vertical scanning circuit 211 supplies the high-level transfer signal trg over the pulse period while setting the selection signal Φ2 to the high level in all the pixels. As a result, the signal level is sampled and held in all the pixels. Furthermore, the level of the pre-stage node 320 decreases from the reset level to the signal level. At timing T25 after timing T24, the vertical scanning circuit 211 returns the selection signal Φ2 to the low level.

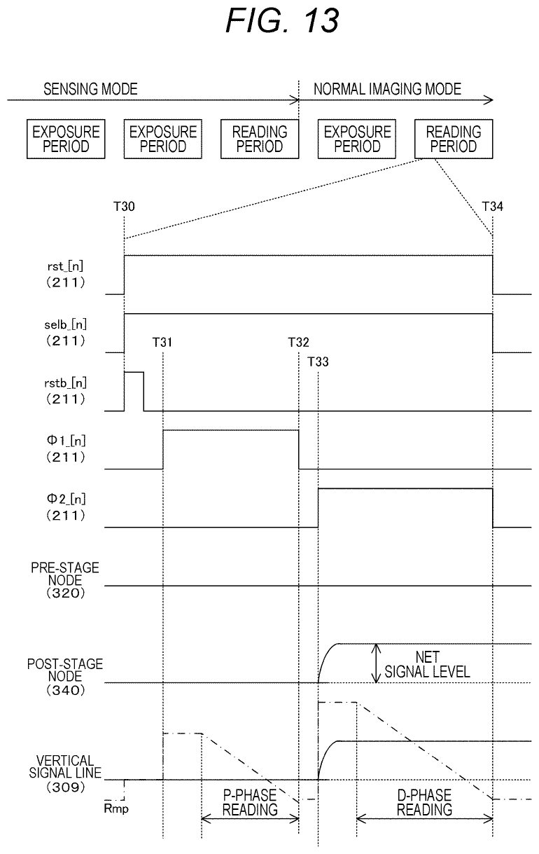

FIG. 13 is a timing chart illustrating an example of a reading operation when the normal imaging mode is set according to the first embodiment of the present technology.

In the reading period of the nth row from timing T30 to timing T34, the vertical scanning circuit 211 sets the FD reset signal rst and the post-stage selection signal selb of the nth row to the high level.

From timing T30 to the pulse period, the vertical scanning circuit 211 supplies the high-level post-stage reset signal rstb to the nth row. As a result, the post-stage node 340 is initialized.

The vertical scanning circuit 211 supplies a high-level selection signal Φ1 to the nth row over a period from timing T31 immediately after timing T30 to timing T32. A potential of the post-stage node 340 becomes a reset level.

The DAC 213 gradually decreases the ramp signal Rmp from immediately after timing T31 to a period of timing T32. The ADC 261 compares the ramp signal Rmp with the level of the vertical signal line 309, and counts a count value until the comparison result is inverted. Therefore, the P-phase level (reset level) is read.

The vertical scanning circuit 211 supplies a high-level selection signal Φ2 to the nth row over a period from timing T33 immediately after timing T32 to timing T34. The potential of the post-stage node 340 increases by a net signal level.

The DAC 213 gradually decreases the ramp signal Rmp from immediately after timing T33 to a period of timing T34. The ADC 261 compares the ramp signal Rmp with the level of the vertical signal line 309, and counts a count value until the comparison result is inverted. Therefore, the D-phase level (signal level) is read.

A waveform of the ramp signal Rmp in the reading period of the P-phase level (reset level) is different from a waveform in the reading period of the D-phase level (signal level). For example, a change amount of the ramp signal Rmp in the reading period of the P-phase level is smaller than a change amount in the reading period of the D-phase level.

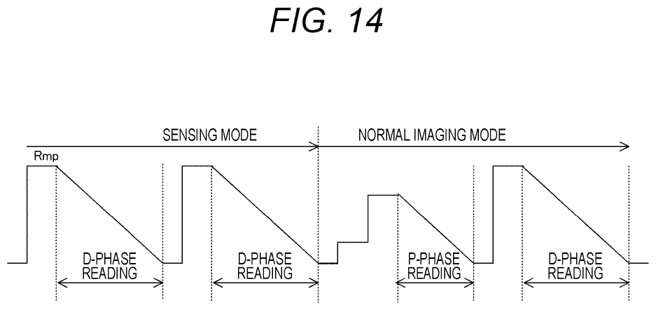

FIG. 14 is a diagram illustrating an example of a waveform of a ramp signal according to the first embodiment of the present technology. The drawing illustrates waveforms within the reading periods. The ramp signal in the exposure period is, for example, constant.

In the sensing mode, the odd-numbered D-phase level and the even-numbered D-phase level are read in order. The waveform of the ramp signal in the reading period of the odd-numbered D-phase level is the same as the waveform in the reading period of the even-numbered D-phase level.

On the other hand, in the normal imaging mode, the P-phase level and the D-phase level are read in order. The waveform of the ramp signal in the reading period of the P-phase level is different from the waveform in the reading period of the D-phase level.

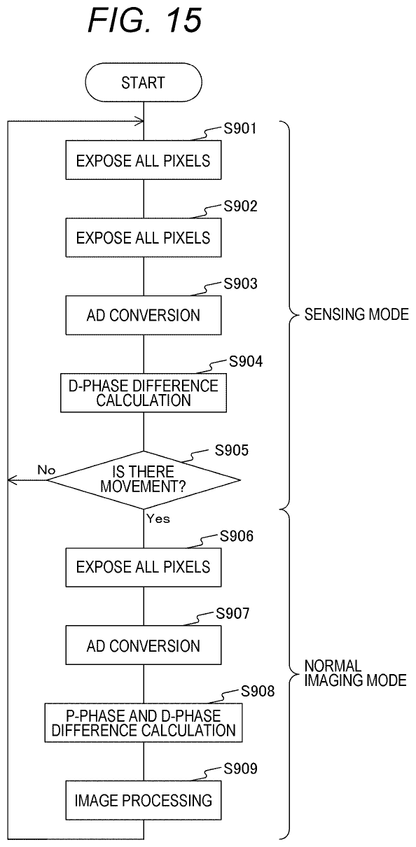

FIG. 15 is a diagram illustrating an example of an operation of the solid-state imaging element 200 according to the first embodiment of the present technology. This operation is started, for example, when the automatic imaging mode is set.

First, a sensing mode is set. The vertical scanning circuit 211 performs odd-numbered exposure to all pixels (step S901) and performs even-numbered exposure to all pixels (step S902). Then, the ADC 261 performs AD conversion on D1 that is the odd-numbered D-phase level and the sum (D1+D2) of D2 that is the even-numbered D-phase level and D1 (step S903), and the difference calculation circuit 263 calculates a difference between D1 and D2 (step S904).

The mode control section 264 determines whether or not there is movement in the subject on the basis of whether or not an absolute value of the difference exceeds a threshold in one or more pixels (step S905). In a case where there is no movement (step S905: No), the solid-state imaging element 200 repeatedly executes steps S901 to S905.

In a case where there is movement (step S905: Yes), the mode is switched to the normal imaging mode, and the vertical scanning circuit 211 exposes all the pixels (step S906). Then, the ADC 261 performs AD conversion on the P-phase level and the D-phase level (step S907), and the difference calculation circuit 263 calculates a difference therebetween (step S908). The image data processing section 265 performs various types of image processing on image data (step S909). After step S909, the solid-state imaging element 200 switches to the sensing mode, and step S901 and subsequent steps are repeated.

Note that, although one piece of image data is captured in the normal imaging mode, two or more pieces of image data can be continuously captured. Furthermore, although the mode is switched to the sensing mode after imaging in the normal imaging mode, the mode may be switched to the manual imaging mode after imaging.

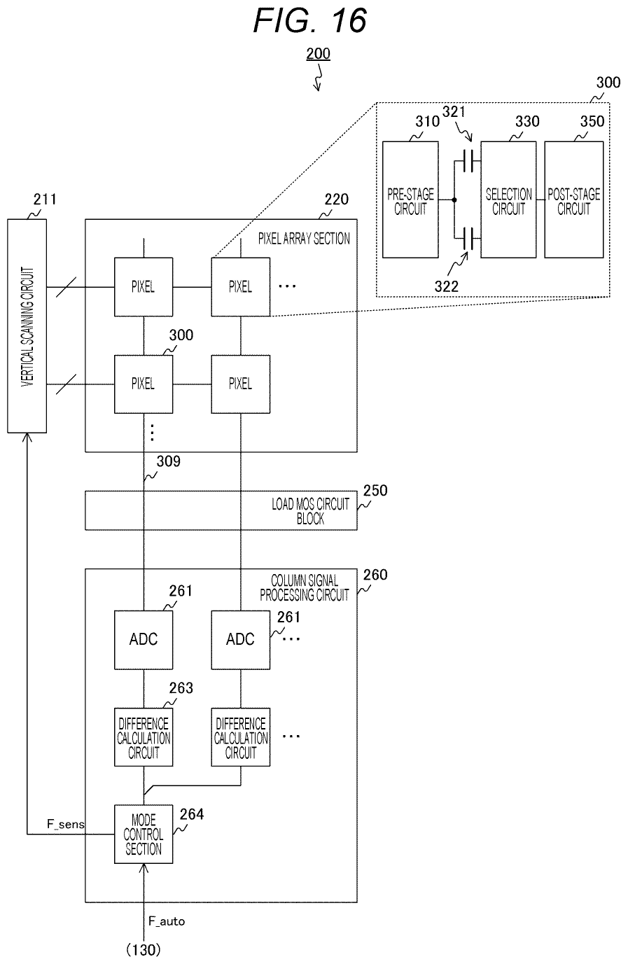

FIG. 16 is an example of an overall view of the solid-state imaging element 200 according to the first embodiment of the present technology. Each of the pixels 300 is provided with the pre-stage circuit 310 that sequentially generates a predetermined number of pixel signals, the capacitive elements 321 and 322, the selection circuit 330, and the post-stage circuit 350.

In a case where the sensing mode is set, the vertical scanning circuit 211 causes the capacitive elements 321 and 322 to hold the respective signal levels of the odd-numbered and even-numbered pixel signals. Furthermore, in a case where the sensing mode is switched to the normal imaging mode, the vertical scanning circuit 211 causes the capacitive elements 321 and 322 to hold the reset level and the signal level of the pixel signal.

In a case where the sensing mode is set, the difference calculation circuit 263 calculates a difference between signal levels of odd-numbered and even-numbered pixel signals. The mode control section 264 determines whether or not to switch from the sensing mode to the normal imaging mode on the basis of the difference. For example, the mode control section 264 determines whether or not to switch the sensing mode to the normal imaging mode on the basis of a comparison result between an absolute value of the difference and a predetermined threshold.

As in Patent Document 1, the automatic imaging mode can also be realized by control of recognizing a voice command and performing imaging according to the command. However, in this configuration, a microphone for inputting voice and a circuit for performing voice recognition are required, and the configuration of the imaging device becomes complicated.

Furthermore, the presence or absence of movement of the subject can be detected by the interframe difference method, but in this configuration, a frame memory for holding image data is required.

On the other hand, in the solid-state imaging element 200 illustrated in the drawing, the odd-numbered and even-numbered signal levels are held by the capacitive elements 321 and 322, and the mode is switched on the basis of a difference therebetween. Therefore, resources and costs of the microphone, the voice recognition processing, the frame memory, and the like can be reduced.

As described above, according to the first embodiment of the present technology, the solid-state imaging element 200 causes the capacitive elements 321 and 322 to hold the odd-numbered and even-numbered signal levels, and switches the mode on the basis of a difference therebetween, and thus, it is possible to realize the automatic imaging mode with a simple configuration.

### [First Modification]

In the first embodiment described above, imaging is performed in a case where there is movement of the subject, but there is a case where focus is not achieved at the time of imaging. A solid-state imaging element 200 according to a first modification of the first embodiment is different from that of the first embodiment in that whether or not to switch to the normal imaging mode is determined on the basis of a difference when a lens is moved to an in-focus position.

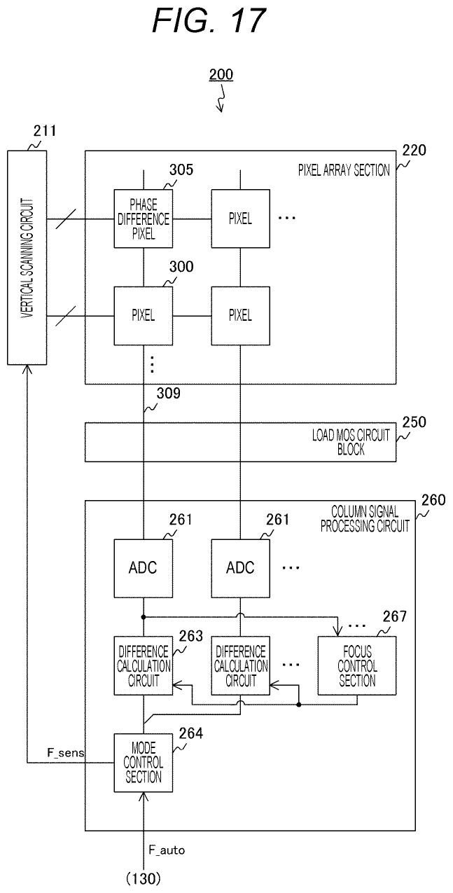

FIG. 17 is an example of an overall view of the solid-state imaging element 200 in the first modification of the first embodiment of the present technology. The solid-state imaging element 200 according to the first modification of the first embodiment is different from that of the first embodiment in that a phase difference pixel 305 is disposed in the pixel array section 220, and a focus control section 266 is further disposed in the column signal processing circuit 260.

The phase difference pixel 305 generates one of a pair of pupil-divided pixel signals. In the pixel array section 220, a plurality of pairs of the phase difference pixels 305 is arranged along a direction in which a phase difference is detected. Note that, although the dedicated phase difference pixels 305 for detecting the phase difference are disposed, the present invention is not limited to this configuration. For example, all the pixels can be configured to detect the phase difference. For example, by disposing a pair of photodiodes and one on chip lens (OCL) for each pixel, it is possible to enable phase difference detection in all pixels. Alternatively, by disposing 2×2 photodiodes and one OCL for each pixel, the phase difference can be detected in all the pixels.

The focus control section 266 detects a pixel signal of each of the plurality of pairs of phase difference pixels 305 and detects an in-focus position of a lens (focus lens) in an optical section 110. The focus control section 266 controls a driver (not illustrated) that drives the lens to move the lens to the detected in-focus position. Furthermore, the focus control section 266 notifies the difference calculation circuit 263 of each column of whether or not the lens has been moved to the in-focus position.

The difference calculation circuit 263 obtains a difference between the signal level D1 before the lens moves to the in-focus position in the sensing mode and the signal level D2 when the lens has moved to the in-focus position. When the lens has moved to the in-focus position, the sum of D1 and D2 is read.

Therefore, similar to the first embodiment, the difference calculation circuit 263 holds the signal level D1 in a memory or the like, and calculates a difference (D2) between the sum of the signal levels D1 and D2 and the held signal level D1. Then, the difference calculation circuit 263 calculates and outputs a difference between the signal level D2 and the held signal level D1

When the lens (such as the focus lens) has moved to the in-focus position, the mode control section 264 determines whether or not to switch the sensing mode to the normal imaging mode on the basis of the difference. For example, in a case where the absolute value of the difference exceeds a threshold in one or more pixels, the sensing mode is switched to the normal imaging mode.

In a case where the subject to be focused moves during a period from the detection to the movement of the lens to the in-focus position, there is a case where focusing is not achieved at the time of the movement to the in-focus position. In this case, since the absolute value of the difference is often less than or equal to the threshold, the solid-state imaging element 200 does not shift to the normal imaging mode and does not perform imaging. On the other hand, if the focusing is achieved at the time of movement to the in-focus position, the absolute value of the difference often exceeds the threshold, and at that time, the solid-state imaging element 200 shifts to the normal imaging mode and performs imaging. As a result, imaging can be performed in a reliably focused state.

As described above, according to the first modification of the first embodiment of the present technology, it is determined whether or not to switch from the sensing mode to the normal imaging mode on the basis of the difference when the lens has moved to the in-focus position, and thus, it is possible to capture focused image data.

### [Second Modification]

In the first embodiment described above, the selection transistors 331 and 332 are inserted in parallel between the capacitive elements 321 and 322 and the post-stage node 340, but these transistors may be connected in series. A solid-state imaging element 200 in a second modification of the first embodiment is different from that of the first embodiment in that the selection transistors 331 and 332 are connected in series.

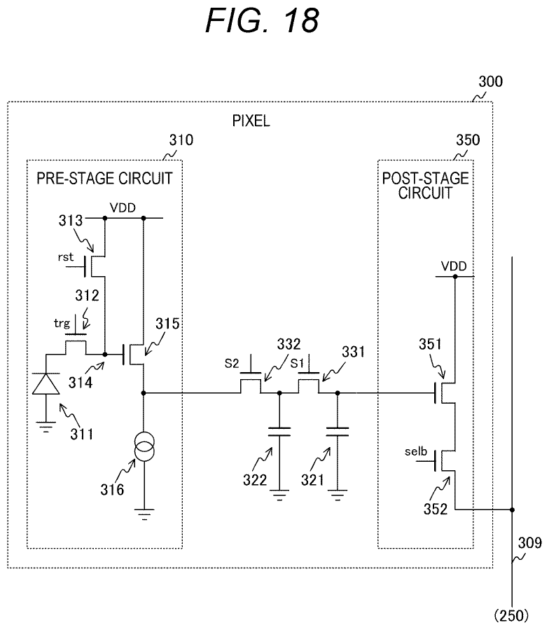

FIG. 18 is a circuit diagram illustrating a configuration example of the pixel 300 in the second modification of the first embodiment of the present technology. In the first modification of the first embodiment, the selection transistors 332 and 331 are connected in series between the pre-stage circuit 310 and the post-stage circuit 350. Furthermore, the capacitive element 322 is inserted between a connection node of the selection transistors 332 and 331 and a ground terminal. The capacitive element 321 is inserted between a connection node of the selection transistor 331 and the post-stage circuit 350 and a ground terminal. Furthermore, the post-stage reset transistor 341 is not disposed.

In a case where the reset level is held in the capacitive element 321 in a mode other than the sensing mode, the vertical scanning circuit 211 closes both the selection transistors 331 and 332 by selection signals S1 and S2. Furthermore, in a case where the signal level is held in the capacitive element 322, the vertical scanning circuit 211 opens the selection transistor 331 and closes the selection transistor 332 by the selection signals S1 and S2.

In the sensing mode, the vertical scanning circuit 211 closes both the selection transistors 331 and 332 by the selection signals S1 and S2, and causes the capacitive element 321 to hold the odd-numbered signal level. Furthermore, the vertical scanning circuit 211 opens the selection transistor 331 and closes the selection transistor 332 by the selection signals S1 and S2, and causes the capacitive element 322 to hold the even-numbered signal level.

Details of a method of controlling the circuit in the drawing are described in, for example, “Chen Xu et al., A Stacked Global-Shutter CMOS Imager with SC-Type Hybrid-GS Pixel and Self-Knee Point Calibration Single-Frame HDR and On-Chip Binarization Algorithm for Smart Vision Applications ISSCC2019.”.

As described above, according to the second modification of the first embodiment of the present technology, since the selection transistors 331 and 332 are connected in series, the post-stage reset transistor 341 can be reduced.

### [Third Modification]

In the first embodiment described above, the post-stage circuit 350 has one system, but this circuit may include two systems. A solid-state imaging element 200 in a third modification of the first embodiment is different from that of the first embodiment in that two systems of the post-stage circuit are provided.

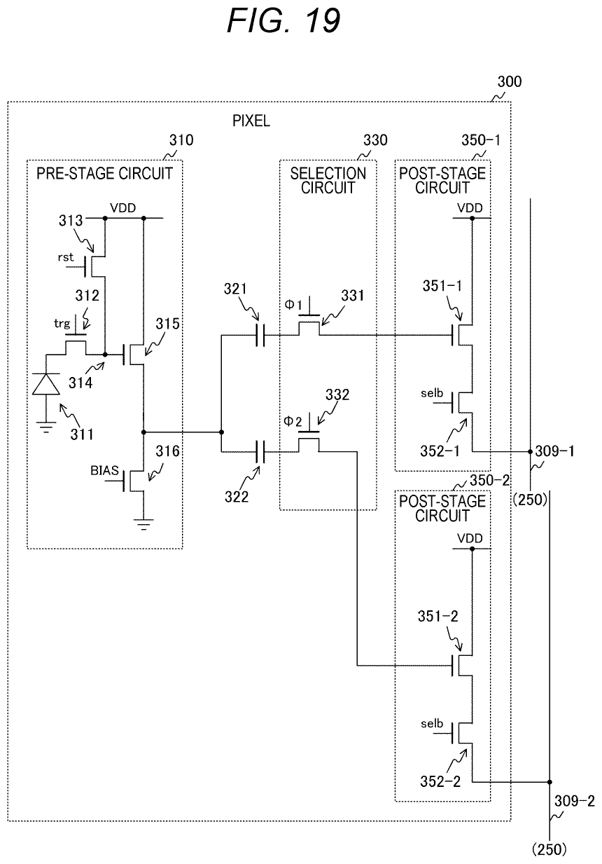

FIG. 19 is a circuit diagram illustrating a configuration example of the pixel 300 in the third modification of the first embodiment of the present technology. The pixel 300 according to the third modification of the first embodiment is different from that of the first embodiment in that the post-stage reset transistor 341 is not disposed, and post-stage circuits 350-1 and 350-2 are disposed instead of the post-stage circuit 350.

The selection transistor 331 opens and closes a path between the capacitive element 321 and the post-stage circuit 350-1, and the selection transistor 332 opens and closes a path between the capacitive element 322 and the post-stage circuit 350-2.

The post-stage circuit 350-1 includes a post-stage amplification transistor 351-1 and a post-stage selection transistor 352-1, and the post-stage circuit 350-2 includes a post-stage amplification transistor 351-2 and a post-stage selection transistor 352-2. Furthermore, two vertical signal lines are wired for each column, the post-stage circuit 350-1 outputs a pixel signal to a vertical signal line 309-1, and the post-stage circuit 350-2 outputs a pixel signal to a vertical signal line 309-2. Furthermore, two ADCs 261 are disposed for each column.

As illustrated in the drawing, the two ADCs 261 are disposed for each column by providing the two post-stage circuits, and two levels (D1, D2, and the like) can be simultaneously AD-converted. As a result, the reading speed is improved.

As described above, according to the third modification of the first embodiment of the present technology, since the post-stage circuit 350 includes two systems, the reading speed can be improved.

### 2. Second Embodiment

In the first embodiment described above, the solid-state imaging element 200 reads both the reset level and the signal level when switching to the normal imaging mode, but in this configuration, it is difficult to further improve the frame rate. The solid-state imaging element 200 according to a second embodiment is different from that of the first embodiment in that only a reset level is read when the mode is switched to the normal imaging mode.

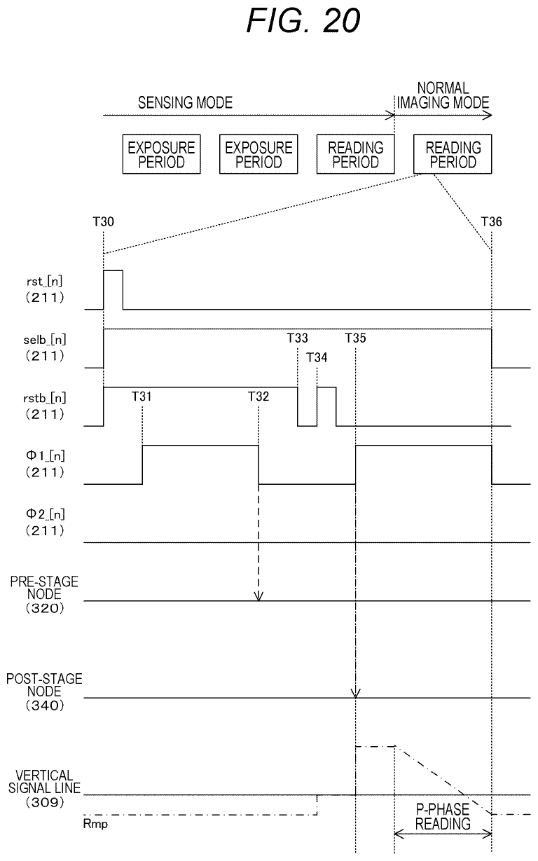

FIG. 20 is a timing chart illustrating an example of a reading operation at the time of switching to the normal imaging mode in the second embodiment of the present technology. The method of controlling the pixel 300 in the sensing mode according to the second embodiment is similar to that according to the first embodiment. However, a difference calculation circuit 263 according to the second embodiment holds a signal level D2 in a memory or the like and calculates a difference between signal levels D1 and D2.

Furthermore, in the second embodiment, when the mode is switched to the normal imaging mode, only a reset level is read. For example, in a reading period of the nth row from timing T30 to timing T36, a vertical scanning circuit 211 sets a post-stage selection signal selb of the nth row to the high level. Furthermore, within a period from timing T30 to timing T33, the vertical scanning circuit 211 sets a post-stage reset signal rstb of the nth row to the high level.

From timing T30 to the pulse period, the vertical scanning circuit 211 supplies a high-level FD reset signal rst to the nth row. Then, the vertical scanning circuit 211 supplies a high-level selection signal Φ1 to the nth row over a period from timing T31 to timing T32. As a result, the reset level is held.

Over the pulse period from timing T34, the vertical scanning circuit 211 supplies the high-level post-stage reset signal rstb to the nth row, and supplies the high-level selection signal Φ1 to the nth row over a period from timing T35 to timing T36.

A DAC 213 gradually decreases a ramp signal Rmp over a period from immediately after timing T35 to timing T36. The ADC 261 compares the ramp signal Rmp with the level of the vertical signal line 309, and counts a count value until the comparison result is inverted. Therefore, the P-phase level (reset level) is read. Then, the difference calculation circuit 263 calculates a difference between the signal level D2 and the reset level. In the sensing mode, since a plurality of D-phase levels (signal levels) is read, the driving of the second embodiment is referred to as D-D-P driving.

As illustrated in the drawing, a solid-state imaging element 200 reads only the reset level when switching to the normal imaging mode. Therefore, an amount of communication between the pixel 300 and a column signal processing circuit 260 can be reduced as compared with the first embodiment in which both the reset level and the signal level are read. It is therefore possible to increase the frame rate.

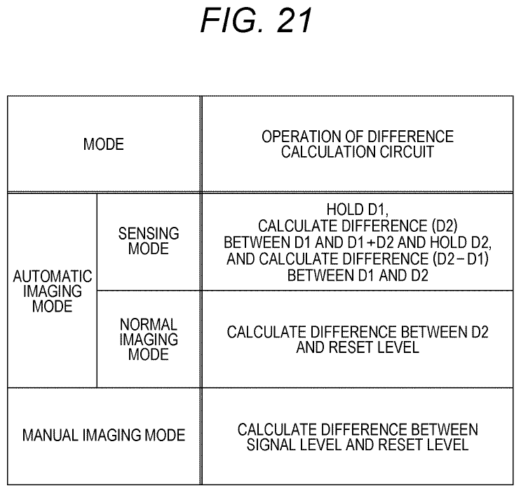

FIG. 21 is a diagram for explaining an operation of the difference calculation circuit 263 according to the second embodiment of the present technology.

In the sensing mode, the difference calculation circuit 263 holds the signal level D1 in a memory or the like. Then, the difference calculation circuit 263 calculates a difference (D2) between the sum of the signal levels D1 and D2 and the held signal level D1. The difference calculation circuit 263 holds the signal level D2 in a memory or the like, calculates a difference between the signal level D2 and the held signal level D1, and outputs the difference.

In the normal imaging mode, the difference calculation circuit 263 calculates a difference between the held signal level D2 and the reset level.

Furthermore, in the manual imaging mode, the difference calculation circuit 263 holds the reset level in a memory or the like. Then, the difference calculation circuit 263 calculates and outputs a difference between the signal level and the held reset level.

Note that each of the first, second, and third modifications of the first embodiment can be applied to the second embodiment.

As described above, according to the second embodiment of the present technology, since the solid-state imaging element 200 reads only the reset level when switching to the normal imaging mode, the frame rate can be improved as compared with the first embodiment.

### 3. Third Embodiment

In the first embodiment described above, the even-numbered exposure is started after the odd-numbered exposure ends, but in this configuration, it is difficult to further improve the frame rate. A solid-state imaging element 200 in a third embodiment is different from that in the first embodiment in that exposure periods of two pixels partially overlap.

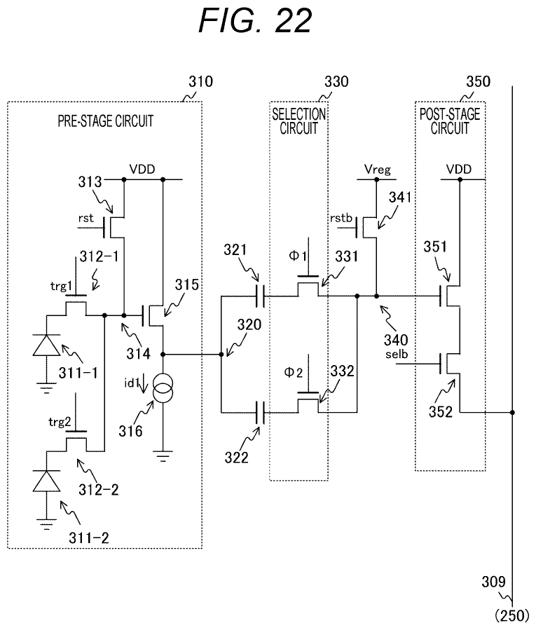

FIG. 22 is a circuit diagram illustrating a configuration example of two pixels according to the third embodiment of the present technology. These two pixels include a pre-stage circuit 310, capacitive elements 321 and 322, a selection circuit 330, a post-stage reset transistor 341, and a post-stage circuit 350.

The pre-stage circuit 310 includes photoelectric conversion elements 311-1 and 311-2, transfer transistors 312-1 and 312-2, an FD reset transistor 313, an FD 314, a pre-stage amplification transistor 315, and a current source transistor 316.

The transfer transistor 312-1 transfers a charge from the photoelectric conversion element 311-1 to the FD 314 in accordance with a transfer signal trg1 from a vertical scanning circuit 211. The transfer transistor 312-2 transfers a charge from the photoelectric conversion element 311-2 to the FD 314 in accordance with a transfer signal trg2 from the vertical scanning circuit 211.

The circuit configuration of a subsequent stage of the transfer transistors 312-1 and 312-2 is similar to that of the first embodiment.

Furthermore, a part of the exposure period of the photoelectric conversion element 311-1 overlaps with the exposure period of the photoelectric conversion element 311-2. Details of the exposure control of these elements will be described later. Note that the photoelectric conversion elements 311-1 and 311-2 are examples of first and second photoelectric conversion elements recited in the claims.

As illustrated in the drawing, by sharing the FD 314 by the two pixels, a circuit scale per pixel can be reduced. Note that the FD 314 is shared by the two pixels, but can also be shared by three or more pixels (four pixels or eight pixels).

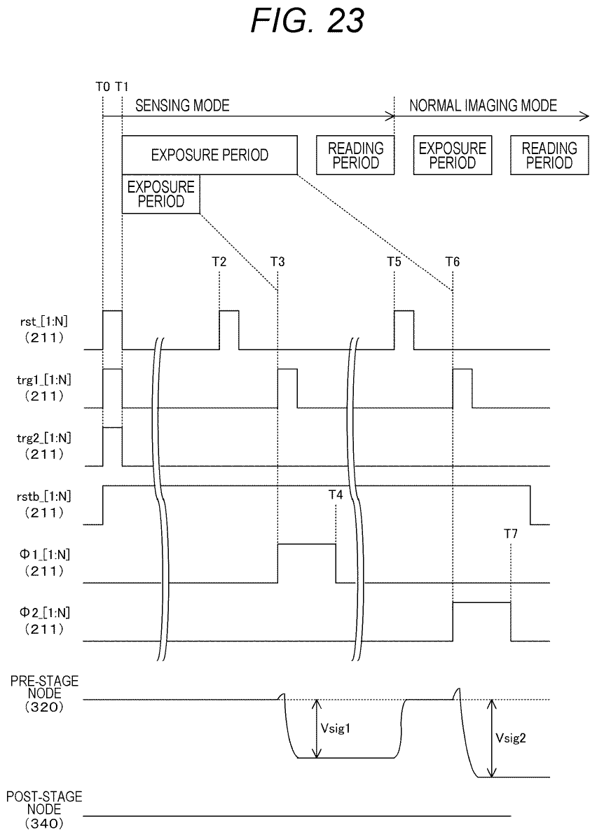

FIG. 23 is a timing chart illustrating an example of a global shutter operation when the sensing mode is set according to the third embodiment of the present technology.

At timing T0 immediately before the exposure period of all the pixels, the vertical scanning circuit 211 sets the post-stage reset signals rstb of all the rows (In other words, all pixels) to the high level. Furthermore, the vertical scanning circuit 211 supplies the high-level FD reset signal rst and the transfer signals trg1 and trg2 to all the pixels over a period from timing T0 to timing T1. Therefore, all the pixels are PD reset, and the exposure simultaneously starts in all the rows.

The exposure period of one of the two pixels sharing the FD 314 partially overlaps with the exposure period of the other pixel. In the example of the drawing, timings T1 to T3 correspond to an exposure period of one of the two pixels, and timings T1 to T6 correspond to an exposure period of the other.

At timing T0 immediately before the exposure period, the vertical scanning circuit 211 sets the post-stage reset signal rstb of all the pixels to the high level. Furthermore, the vertical scanning circuit 211 supplies the high-level FD reset signal rst and the transfer signals trg1 and trg2 to all the pixels over a period from timing T0 to timing T1. Therefore, all the pixels are PD reset, and the exposure simultaneously starts in all the rows.

Then, at timing T2 immediately before the end of the shorter exposure period, the vertical scanning circuit 211 supplies the high-level FD reset signal rst over the pulse period. As a result, one of the two pixels sharing the FD 314 is FD-reset.

At exposure end timing T3 in the shorter exposure period, the vertical scanning circuit 211 supplies the high-level transfer signal trg1 over the pulse period while setting the selection signal Φ1 to the high level in all the pixels. As a result, a signal level Vsig1 corresponding to the exposure amount is sampled and held in one of the two pixels. At timing T4 after timing T3, the vertical scanning circuit 211 returns the selection signal Φ1 to the low level.

Then, at timing T5 immediately before the end of the longer exposure period, the vertical scanning circuit 211 supplies the high-level FD reset signal rst over the pulse period. As a result, the other of the two pixels sharing the FD 314 is FD-reset.

At exposure end timing T6 in the longer exposure period, the vertical scanning circuit 211 supplies the high-level transfer signal trg1 over the pulse period while setting the selection signal Φ2 to the high level in all the pixels. As a result, a signal level Vsig2 corresponding to the exposure amount is sampled and held in the other of the two pixels. At timing T7 after timing T6, the vertical scanning circuit 211 returns the selection signal Φ2 to the low level.

The control of the reading period in the sensing mode in the third embodiment is similar to that in the first embodiment. During this reading period, one signal level Vsig1 and the other signal level Vsig2 of the two pixels sharing the FD are read. A digital signal processing section 262 determines whether or not to switch to the normal imaging mode on the basis of a difference between the signal levels.

Here, since the exposure time of one of the two pixels sharing the FD is different from the exposure time of the other pixel, a difference occurs in the exposure amount of each of the two pixels regardless of the presence or absence of movement of the subject. However, when the shorter exposure time is Ta, a difference in exposure time is dT, and dT/Ta is sufficiently reduced, the difference in exposure amount is reduced to a negligible extent when the illuminance is relatively low.

Note that the digital signal processing section 262 can also correct the signal level of one of the two pixels according to the difference between the exposure amounts of the two pixels. In this case, for example, the shorter exposure time may be Ta, the longer exposure period may be Tb, and the signal level of the shorter exposure period is only required to be multiplied by Tb/Ta, or the signal level of the longer exposure time is only required to be multiplied by Ta/Tb. After this correction, the mode is controlled on the basis of the difference in signal level.

As illustrated in the drawing, since a part of the exposure period of one of the two pixels sharing FD overlaps with the exposure period of the other, the frame rate can be improved as compared with the first embodiment.

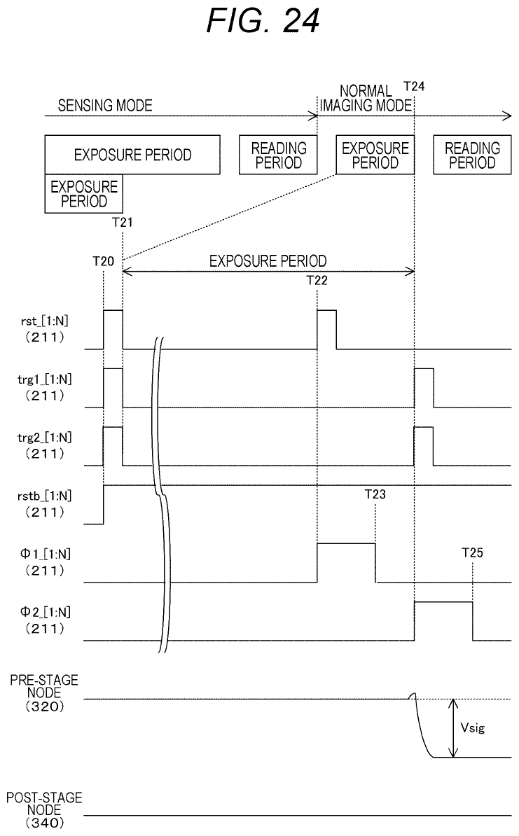

FIG. 24 is a timing chart illustrating an example of the global shutter operation when the mode is switched to the normal imaging mode according to the third embodiment of the present technology.

At timing T20, the vertical scanning circuit 211 sets the post-stage reset signal rstb of all the pixels to the high level. Furthermore, the vertical scanning circuit 211 supplies the high-level FD reset signal rst and transfer signals trg1 and trg2 to all the pixels over a period from timing T20 to timing T21. Therefore, all the pixels are PD reset, and the exposure simultaneously starts in all the rows.

At timing T22 immediately before the end of the exposure, the vertical scanning circuit 211 supplies the high-level FD reset signal rst over the pulse period while setting the selection signal Φ1 to the high level in all the pixels. Therefore, all the pixels are FD reset, and the reset level is sampled and held. At timing T23 after timing T22, the vertical scanning circuit 211 returns the selection signal Φ1 to the low level.

At exposure end timing T24, the vertical scanning circuit 211 supplies the high-level transfer signals trg1 and trg2 over the pulse period while setting the selection signal Φ2 to the high level in all the pixels. As a result, the signal level is sampled and held. Furthermore, the level of the pre-stage node 320 decreases from the reset level to the signal level. At timing T25 after timing T24, the vertical scanning circuit 211 returns the selection signal Φ2 to the low level.

As illustrated in the drawing, since the transfer signals trg1 and trg2 are simultaneously supplied, the two pixels sharing the FD 314 are subjected to pixel addition. This is because, in a case where the FD 314 is shared by the two pixels, there are only two capacitive elements per two pixels, and only one reset level and one signal level can be sampled and held. As a result, a resolution of the image data is halved as compared with the first embodiment that does not share the FD 314.

The control of the reading period in the normal imaging mode in the third embodiment is similar to that in the first embodiment.

Note that the first, second, and third modifications of the first embodiment, and the second embodiment can be applied to the third embodiment.

As described above, according to the third embodiment of the present technology, since the exposure periods of the two pixels sharing the FD 314 overlap with each other, the frame rate can be improved. Furthermore, since the FD 314 is shared by the two pixels, a circuit scale per pixel can be reduced.

### 4. Fourth Embodiment

In the first embodiment described above, the solid-state imaging element 200 drives the pixels by the driving method illustrated in FIGS. 9 to 13, but is not limited to this driving method. A solid-state imaging element 200 of a fourth embodiment is different from that of the first embodiment in that a timing of resetting a post-stage node is different.

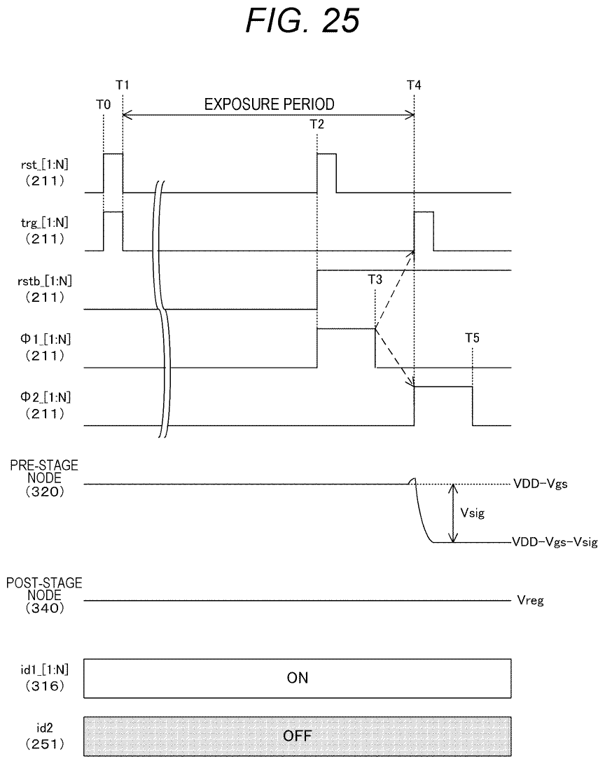

FIG. 25 is a timing chart illustrating an example of a global shutter operation according to the fourth embodiment of the present technology. The drawing illustrates control in an exposure period other than the sensing mode.

In the fourth embodiment, a post-stage reset signal rstb is controlled to the high level at timing T2 when an FD reset signal rst is controlled to the high level. Similarly in the exposure period of the sensing mode, the post-stage reset signal rstb is controlled to the high level at the timing when the FD reset signal rst is controlled to the high level.

In the sensing mode, since a post-stage node 340 is initialized after an odd-numbered signal level D1 is read, the post-stage node 340 becomes D2 instead of D1+D2 at the even-numbered reading. Therefore, a difference calculation circuit 263 does not need to hold D1, and the configuration of the difference calculation circuit 263 can be simplified.

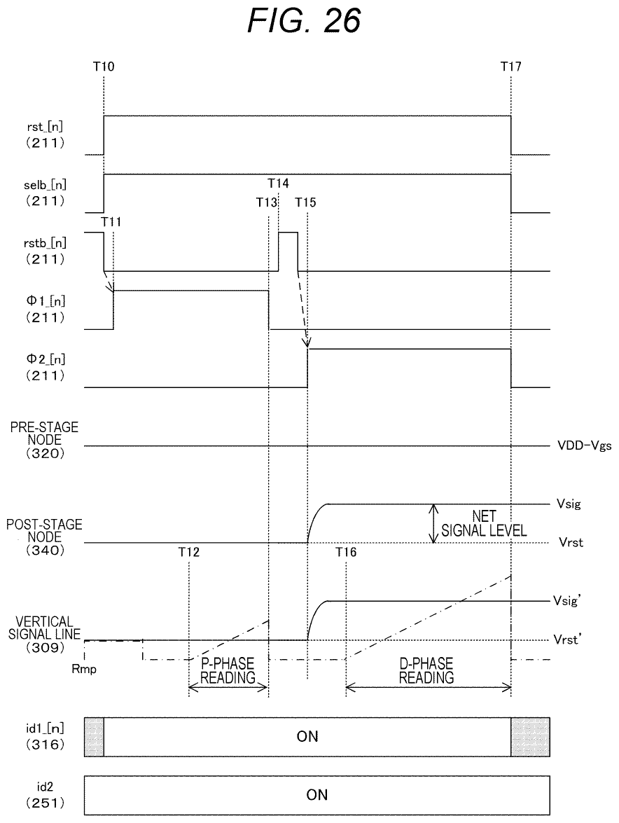

FIG. 26 is a timing chart illustrating an example of a reading operation according to the fourth embodiment of the present technology. The drawing illustrates control in a reading period other than the sensing mode.

In the fourth embodiment, the post-stage reset signal rstb is supplied over a pulse period from timing T14 immediately after timing T13 at which the reset level is read. Similarly in the sensing mode, the post-stage reset signal rstb is supplied from the timing immediately after the timing at which the first signal level is read over the pulse period.

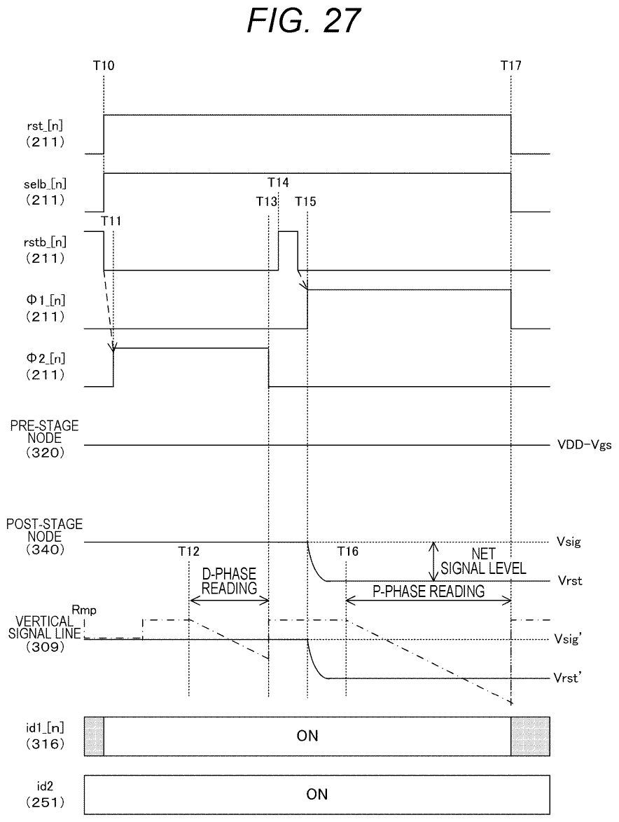

Note that the solid-state imaging element 200 reads the signal level after the reset level, but is not limited to this order. As illustrated in FIG. 27, the solid-state imaging element 200 can also read the reset level after the signal level. In this case, as illustrated in the drawing, the vertical scanning circuit 211 supplies a high-level selection signal Φ1 after a high-level selection signal Φ2. Furthermore, in this case, it is necessary to reverse the gradient of the slope of the ramp signal.

As described above, according to the fourth embodiment of the present technology, the pixels can be driven by the driving method different from that of the first embodiment.

### [First Modification]

In the above-described fourth embodiment, the pre-stage circuit 310 reads a signal while being connected to the pre-stage node 320, but with this configuration, noise from the pre-stage node 320 cannot be cut off at the time of reading. The pixel 300 according to a first modification of the fourth embodiment is different from that of the fourth embodiment in that a transistor is inserted between the pre-stage circuit 310 and the pre-stage node 320.

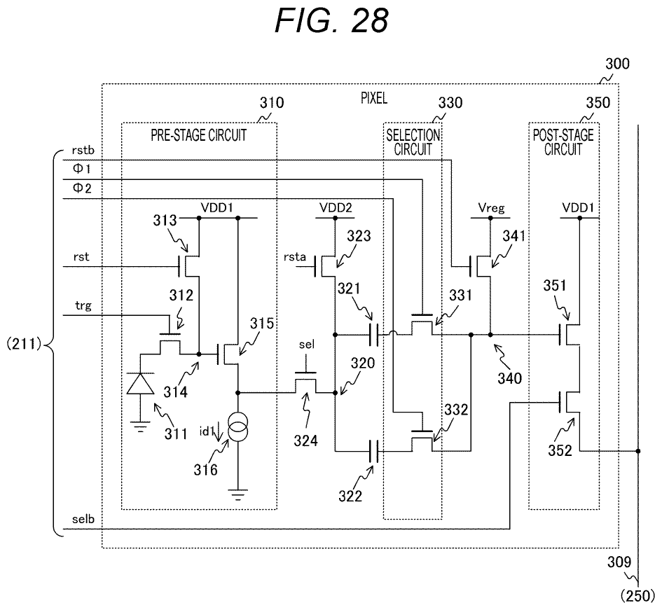

FIG. 28 is a circuit diagram illustrating a configuration example of the pixel 300 in the first modification of the fourth embodiment of the present technology. The pixel 300 according to the first modification of the fourth embodiment is different from that of the fourth embodiment in further including a pre-stage reset transistor 323 and a pre-stage selection transistor 324. Furthermore, power supply voltages of the pre-stage circuit 310 and the post-stage circuit 350 of the first modification of the fourth embodiment are VDD1.

The pre-stage reset transistor 323 initializes the level of the pre-stage node 320 with a power supply voltage VDD2. It is desirable that the power supply voltage VDD2 be set to a value satisfying the following formula.

$$VDD 2 = VDD 1 - Vgs \qquad Formula 1$$

In the above formula, Vgs indicates a gate-source voltage of the pre-stage amplification transistor 315.

By setting the value to a value that satisfies Formula 1, it is possible to reduce the potential fluctuation between the pre-stage node 320 and the post-stage node 340 in the dark. It is therefore possible to improve photo response non-uniformity (PRNU).

The pre-stage selection transistor 324 opens and closes a path between the pre-stage circuit 310 and the pre-stage node 320 in accordance with a pre-stage selection signal sel from the vertical scanning circuit 211.

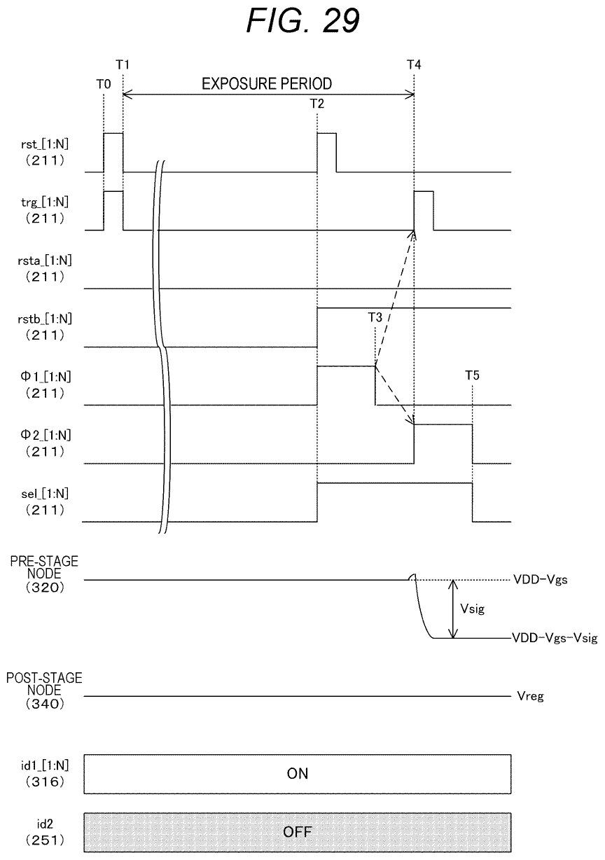

FIG. 29 is a timing chart illustrating an example of a global shutter operation in the first modification of the fourth embodiment of the present technology. The drawing illustrates control other than the sensing mode. The timing chart of the first modification of the fourth embodiment is different from that of the fourth embodiment in that the vertical scanning circuit 211 further supplies a pre-stage reset signal rsta and a pre-stage selection signal sel. In the drawing, rsta_[n] and sel_[n] indicate signals to pixels in the n-th row.

The vertical scanning circuit 211 supplies a high-level pre-stage selection signal sel to all the pixels over a period from timing T2 immediately before the end of exposure to timing T5. The pre-stage reset signal rsta is controlled to the low level.

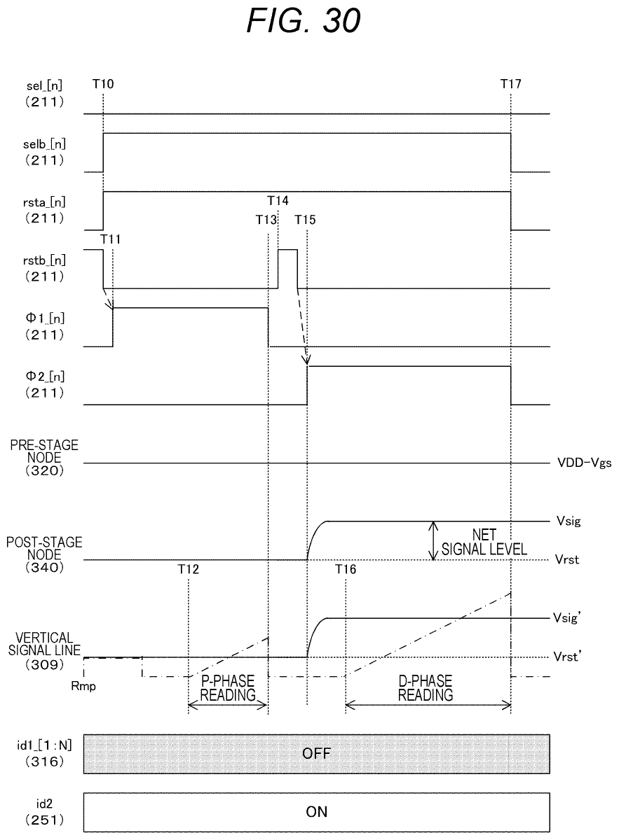

FIG. 30 is a timing chart illustrating an example of a reading operation in the first modification of the fourth embodiment of the present technology. The drawing illustrates control other than the sensing mode. At the time of reading of each row, the pre-stage selection signal sel is controlled to the low level. This control brings the pre-stage selection transistor 324 into the open state to disconnect the pre-stage node 320 from the pre-stage circuit 310. It is therefore possible to block noise from the pre-stage node 320 at the time of reading.

Furthermore, over the reading period of the n-th row from timing T10 to timing T17, the vertical scanning circuit 211 supplies the high-level pre-stage reset signal rsta to the n-th row.

Furthermore, at the time of reading, the vertical scanning circuit 211 controls the current source transistors 316 of all the pixels to stop the supply of the current id1. The current id2 is supplied similarly to the fourth embodiment. As described above, the control of the current id1 is simplified as compared with the fourth embodiment.

As described above, according to the first modification of the fourth embodiment of the present technology, the pre-stage selection transistor 324 shifts to an open state at the time of reading, and the pre-stage circuit 310 is disconnected from the pre-stage node 320, so that noise from the pre-stage circuit 310 can be cut off.

### [Second Modification]

In the fourth embodiment described above, the circuits in the solid-state imaging element 200 are disposed in a single semiconductor chip. With this configuration, however, there is a possibility that the elements might not fit in the semiconductor chip when the pixels 300 are miniaturized. The solid-state imaging element 200 according to a second modification of the fourth embodiment is different from that of the fourth embodiment in that circuits in the solid-state imaging element 200 are dispersedly disposed on two semiconductor chips.

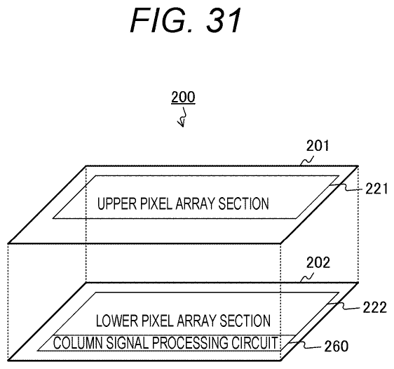

FIG. 31 is a diagram illustrating an example of a stacked structure of the solid-state imaging element 200 in the second modification of the fourth embodiment of the present technology. The solid-state imaging element 200 according to the second modification of the fourth embodiment includes a circuit chip 201 and a pixel chip 201 stacked on the circuit chip 201. These chips are electrically connected by, for example, Cu—Cu bonding. Note that, in addition to the Cu—Cu bonding, the connection can be made using a via or a bump.

An upper pixel array section 221 is disposed on the circuit chip 201. In the pixel chip 202, a lower pixel array section 222 and a column signal processing circuit 260 are disposed. For each pixel in the pixel array section 220, a part of the pixel is disposed in the upper pixel array section 221, and the rest is disposed in the lower pixel array section 222.

Furthermore, in the circuit chip 202, the vertical scanning circuit 211, the timing control circuit 212, the DAC 213, and the load MOS circuit block 250 are also disposed. These circuits are not illustrated in the drawing.

Furthermore, the pixel chip 201 is manufactured, for example, by a pixel-dedicated process, and the circuit chip 202 is manufactured, for example, by a complementary MOS (CMOS) process.

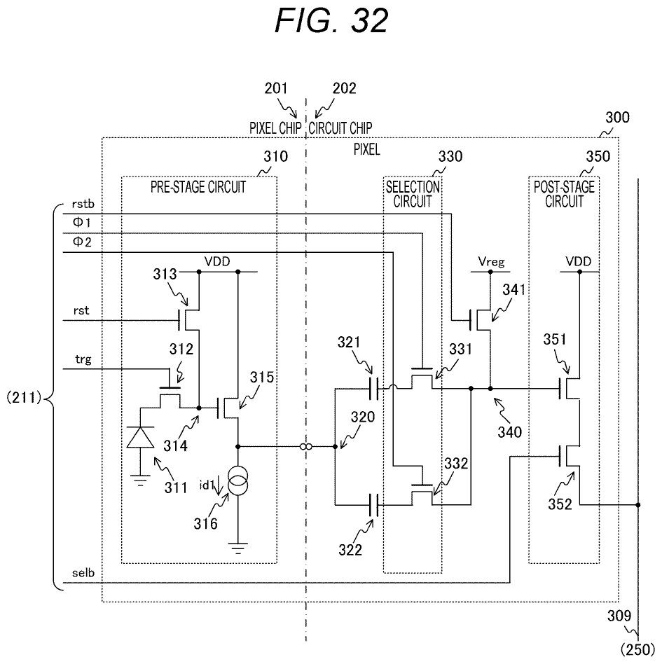

FIG. 32 is a circuit diagram illustrating a configuration example of the pixel 300 in the second modification of the fourth embodiment of the present technology. In the pixel 300, the pre-stage circuit 310 is disposed on the pixel chip 201, and other circuits and elements (such as the capacitive elements 321 and 322) are disposed on the circuit chip 202. Note that the current source transistor 316 can be further disposed in the circuit chip 202. As illustrated in the drawing, by dispersedly disposing the elements in the pixel 300 on the stacked pixel chip 201 and circuit chip 202, an area of the pixel can be reduced, and miniaturization of the pixel is facilitated.

As described above, according to the second modification of the fourth embodiment of the present technology, since the circuits and elements in the pixel 300 are dispersedly disposed on the two semiconductor chips, miniaturization of the pixel is facilitated.

### [Third Modification]

In the second modification of the fourth embodiment described above, a part of the pixel 300 and the peripheral circuit (such as the column signal processing circuit 260) are provided in the lower circuit chip 202. However, with this configuration, an arrangement area of the circuits and elements on the circuit chip 202 side is larger than that of the pixel chip 201 by the peripheral circuit, and there is a possibility that an unnecessary space without circuits and elements is generated in the pixel chip 201. The solid-state imaging element 200 according to a third modification of the fourth embodiment is different from the second modification of the fourth embodiment in that circuits in the solid-state imaging element 200 are dispersedly disposed on three semiconductor chips.

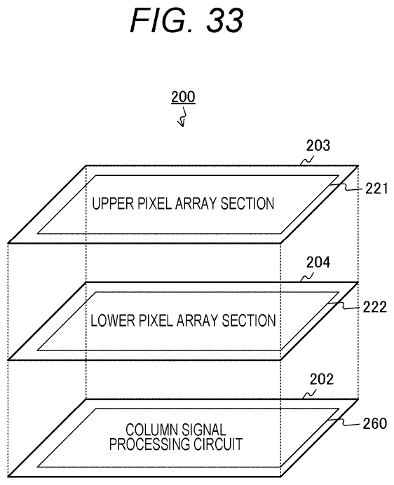

FIG. 33 is a diagram illustrating an example of a stacked structure of the solid-state imaging element 200 in the third modification of the fourth embodiment of the present technology. The solid-state imaging element 200 according to the third modification of the fourth embodiment includes an upper pixel chip 203, a lower pixel chip 204, and a circuit chip 202. These chips are stacked and are electrically connected by, for example, Cu—Cu bonding. Note that, in addition to the Cu—Cu bonding, the connection can be made using a via or a bump.

The upper pixel array section 221 is disposed in the upper pixel chip 203. The lower pixel array section 222 is disposed in the lower pixel chip 204. For each pixel in the pixel array section 220, a part of the pixel is disposed in the upper pixel array section 221, and the rest is disposed in the lower pixel array section 222.

Furthermore, in the circuit chip 202, the column signal processing circuit 260, the vertical scanning circuit 211, the timing control circuit 212, the DAC 213, and the load MOS circuit block 250 are disposed. Circuits other than the column signal processing circuit 260 are not illustrated in the drawing.

Adopting the three-layer configuration as illustrated in the drawing allows a reduction in unnecessary space and allows further pixel miniaturization as compared with the two-layer configuration. Furthermore, the lower pixel chip 204 that is a second layer can be manufactured by a dedicated process for the capacitor and switch.

As described above, in the third modification of the fourth embodiment of the present technology, since the circuits in the solid-state imaging element 200 are dispersedly disposed on the three semiconductor chips, the pixels can be further miniaturized as compared with a case where the circuits are dispersedly disposed on the two semiconductor chips.

### 5. Fifth Embodiment

In the above-described fourth embodiment, the reset level is sampled and held in the exposure period, but in this configuration, the exposure period cannot be made shorter than the sample and hold period of the reset level. A solid-state imaging element 200 according to a fifth embodiment differs from that of the first embodiment in that a transistor that discharges a charge from the photoelectric conversion elements is added to make the exposure period shorter.

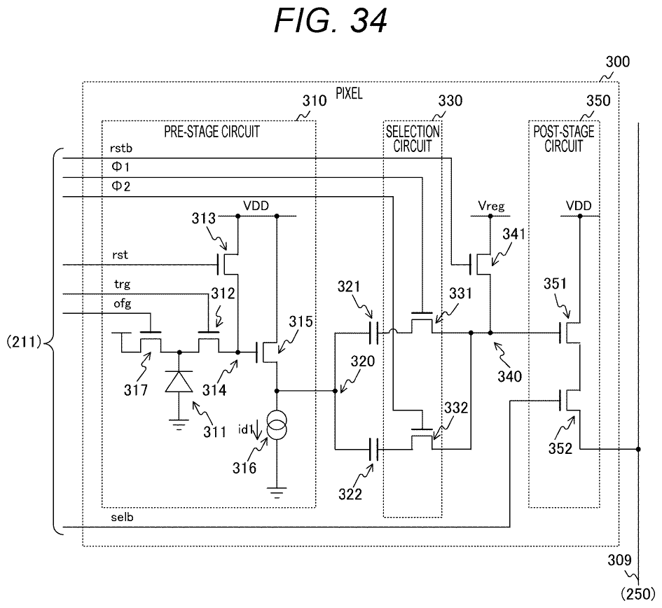

FIG. 34 is a circuit diagram illustrating a configuration example of the pixel 300 according to the fifth embodiment of the present technology. The pixel 300 of the fifth embodiment is different from that of the fourth embodiment in that a discharge transistor 317 is further provided in a pre-stage circuit 310.

The discharge transistor 317 functions as an overflow drain that discharges a charge from the photoelectric conversion element 311 in accordance with a discharge signal ofg from the vertical scanning circuit 211. As the discharge transistor 317, for example, an nMOS transistors is used.

In the configuration in which the discharge transistor 317 is not provided as in the fourth embodiment, blooming may occur when charges are transferred from the photoelectric conversion element 311 to the FD 314 for all pixels. Then, at the time of FD reset, the potential of the FD 314 and the potential of the pre-stage node 320 drop. In response to the potential drop, charging and discharging currents of the capacitive elements 321 and 322 continue to occur, and IR drop in the power supply or the ground changes from a steady state without blooming.

On the other hand, at the time of sampling and holding the signal levels of all the pixels, after the transfer of the signal charges, the photoelectric conversion element 311 has no charge, so that blooming does not occur, and IR drop in the power supply or the ground goes into the steady state without blooming. Due to a difference in IR drop at the time of sampling and holding the reset level and the signal level, streaking noise occurs.

In the fifth embodiment in which the discharge transistor 317 is provided, on the other hand, the electric charge in the photoelectric conversion element 311 is discharged to a side of the overflow drain. Therefore, IR drops at the time of sampling and holding the reset level and the signal level become almost identical to each other, so that it is possible to suppress streaking noise.

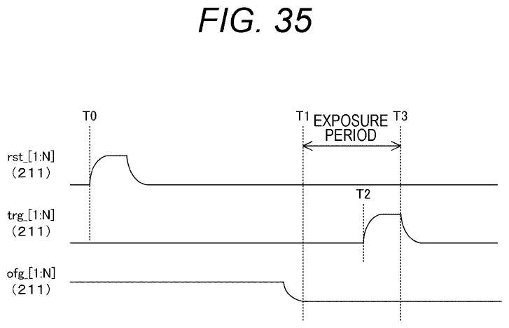

FIG. 35 is a timing chart illustrating an example of a global shutter operation according to the fifth embodiment of the present technology. At timing T0 before the start of exposure, the vertical scanning circuit 211 supplies the high-level FD reset signal rst to all the pixels over the pulse period while setting the discharge signal ofg to the high level for all the pixels. Therefore, the PD reset and the FD reset are performed on all the pixels. Furthermore, the reset level is sampled and held. Here, ofg_[n] in the drawing indicates signals to pixels in the n-th row of the N rows.

Then, at timing T1 that is the start of exposure, the vertical scanning circuit 211 returns the discharge signal ofg to the low level for all the pixels. Then, the vertical scanning circuit 211 supplies the high-level transfer signal trg to all the pixels over a period from timing T2 immediately before the end of exposure to timing T3 that is the end of exposure. As a result, the signal level is sampled and held.

In the configuration in which the discharge transistor 317 is not provided as in the fourth embodiment, both the transfer transistor 312 and the FD reset transistor 313 need to be turned on at the start of exposure (that is, at the time of PD reset). Under this control, the FD 314 also needs to be reset at the time of PD reset. It is therefore necessary to perform the FD reset again within the exposure period to sample and hold the reset level, so that the exposure period cannot be made shorter than the sample and hold period of the reset level. When the reset levels of all the pixels are sampled and held, a certain waiting time is required until the voltage and the current settle, and for example, a sample and hold period of several microseconds (μs) to several tens of microseconds (μs) is required.

In the fifth embodiment in which the discharge transistor 317 is provided, on the other hand, the PD reset and the FD reset can be performed separately from each other. Therefore, as illustrated in the drawing, it is possible to sample and hold the reset level by performing the FD reset before cancellation of the PD reset (the start of exposure). It is therefore possible to make the exposure period shorter than the sample and hold period of the reset level.

Note that the first to third modifications of the fourth embodiment can also be applied to the fifth embodiment.

As described above, according to the fifth embodiment of the present technology, the discharge transistor 317 that discharges electric charge from the photoelectric conversion element 311 is provided, so that it becomes possible to sample and hold the reset level by performing the FD reset before the start of exposure. It is therefore possible to make the exposure period shorter than the sample and hold period of the reset level.

### 6. Sixth Embodiment

In the above-described fourth embodiment, the FD 314 is initialized by the power supply voltage VDD. However, in this configuration, there is a possibility that photo response non-uniformity (PRNU) is deteriorated due to variations in the capacitive elements 321 and 322 and parasitic capacitance. A solid-state imaging element 200 of the sixth embodiment is different from that of the fourth embodiment in improving the PRNU by lowering the power supply of an FD reset transistor 313 at the time of reading.

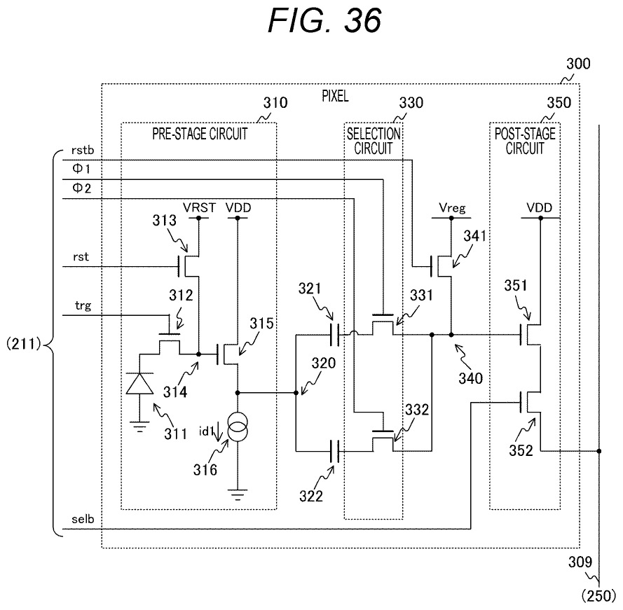

FIG. 36 is a circuit diagram illustrating a configuration example of a pixel 300 according to the sixth embodiment of the present technology. The pixel 300 of the sixth embodiment is different from that of the fourth embodiment in that the power supply of the FD reset transistor 313 is separated from the power supply voltage VDD of the pixel 300.

The FD reset transistor 313 of the sixth embodiment has its drain connected to a reset power supply voltage VRST. The reset power supply voltage VRST is controlled by, for example, the timing control circuit 212.

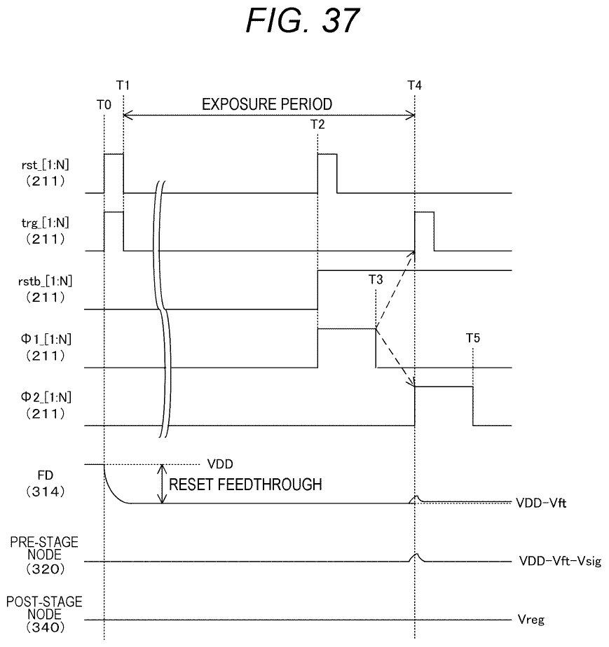

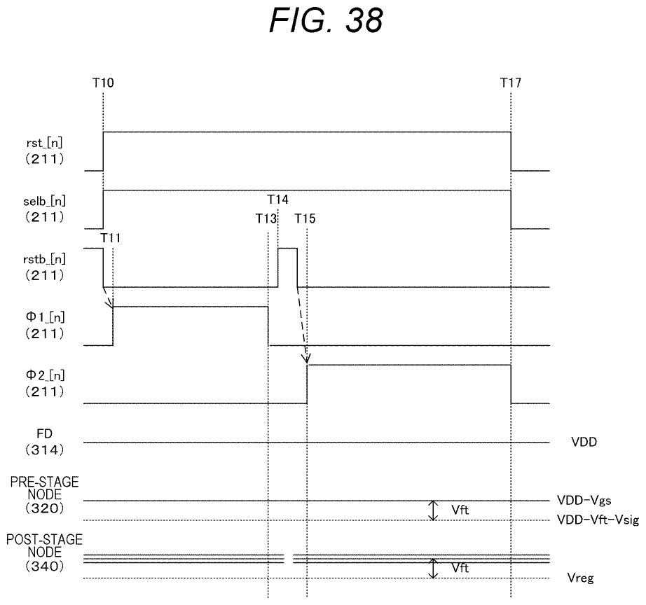

Here, deterioration of the PRNU in the pixel 300 of the fourth embodiment will be considered with reference to FIGS. 37 and 38. These drawings illustrate control other than the sensing mode. In the fourth embodiment, as illustrated in FIG. 37, at timing T0 immediately before the exposure start time, the potential of the FD 314 decreases due to reset feedthrough of the FD reset transistor 313. An amount of this variation is denoted as Vft.

In the fourth embodiment, since the power supply voltage of the FD reset transistor 313 is VDD, the potential of the FD 314 varies from VDD to VDD−Vit at timing T0. Furthermore, the potential of the pre-stage node 320 at the time of exposure is VDD−Vft−Vgs.

Furthermore, in the fourth embodiment, as illustrated in FIG. 37, the FD reset transistor 313 shifts to an on state at the time of reading, and the FD 314 is fixed to the power supply voltage VDD. Due to the variation Vft of the FD 314, the potential of the pre-stage node 320 and the potential of the post-stage node 340 at the time of reading are shifted higher by approximately Vft. However, due to variations in capacitance values of the capacitive elements 321 and 322 or parasitic capacitance, the shift voltage amount varies for each pixel, which causes deterioration of PRNU.

A shift amount of the post-stage node 340 in a case where the pre-stage node 320 is shifted by Vft is expressed by, for example, the following formula.

$$\{ ( Cs + δ Cs ) / ( Cs + δ Cs + Cp ) \} ⋆ Vft \qquad Formula 2$$

In the above formula, Cs is a capacitance value of the capacitive element 322 on the signal level side, and OCs is a variation in Cs. Cp is a capacitance value of the parasitic capacitance of the post-stage node 340.

Formula 2 can be approximated by the following formula.

$$\{ 1 - ( δ Cs / Cs ) * ( Cp / Cs ) \} ⋆ Vft \qquad Formula 3$$

According to Formula 3, the variation of the post-stage node 340 can be expressed by the following formula.

$$\{ ( δ Cs / Cs ) * ( Cp / Cs ) \} ⋆ Vft \qquad Formula 4$$

With (δCs/Cs) set to 10⁻², (Cp/Cs) set to 10⁻¹, and Vft set to 400 millivolt (mV), PRNU is 400 μVrms according to Formula 4, which is a relatively large value.

In particular, in order to reduce kTC noise at the time of sampling and holding input conversion capacitance, it is necessary to increase a charge-voltage conversion efficiency of the FD 314. In order to increase the charge-voltage conversion efficiency, it is necessary to reduce the capacitance of the FD 314, but the smaller the capacitance of the FD 314, the larger the variation Vft, which may be several hundred millivolts (mV). In this case, the influence of the PRNU might become too large to ignore, according to Formula 4.

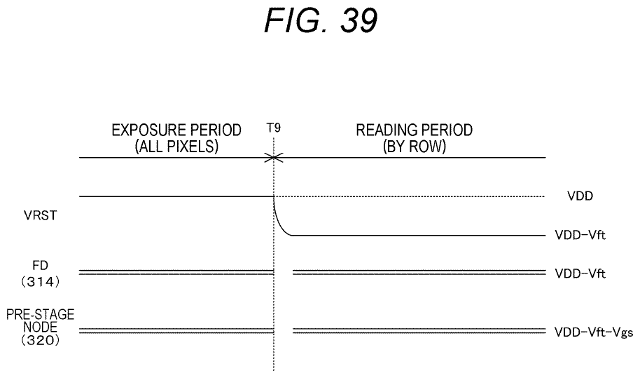

FIG. 39 is a timing chart illustrating an example of voltage control according to the sixth embodiment of the present technology. The drawing illustrates control other than the sensing mode.

The timing control circuit 212 performs control to make the reset power supply voltage VRST for the row-by-row reading period after timing T9 different from the reset power supply voltage VRST for the exposure period.

For example, for the exposure period, the timing control circuit 212 sets the reset power supply voltage VRST identical to the power supply voltage VDD. On the other hand, for the reading period, the timing control circuit 212 decreases the reset power supply voltage VRST to VDD−Vft. That is, for the reading period, the timing control circuit 212 decreases the reset power supply voltage VRST by amount approximately equal to the variation Vft caused by reset feedthrough. This control allows the reset level of the FD 314 at the time of exposure and the reset level at the time of reading to be identical to each other.

Controlling the reset power supply voltage VRST allows, as illustrated in the drawing, a reduction in variations in voltage of the FD 314 and the pre-stage node 320. It is therefore possible to suppress variations of the capacitive elements 321 and 322 and deterioration of PRNU due to parasitic capacitance.

Note that the first to third modifications of the fourth embodiment, and the fifth embodiment can also be applied to the sixth embodiment.

As described above, according to the sixth embodiment of the present technology, the timing control circuit 212 lowers the reset power supply voltage VRST by the amount of variation Vit caused by reset feedthrough at the time of reading, so that the reset level at the time of exposure and the reset level at the time of reading can be made equal to each other. It is therefore possible to suppress deterioration of photo response non-uniformity (PRNU).

### 7. Seventh Embodiment

In the above-described fourth embodiment, the signal level is read next to the reset level for each frame in a mode other than the sensing mode. However, in this configuration, there is a possibility that photo response non-uniformity (PRNU) deteriorates due to variations in the capacitive elements 321 and 322 or parasitic capacitance. A solid-state imaging element 200 of the seventh embodiment is different from that of the fourth embodiment in that the PRNU is improved by switching the level held in the capacitive element 321 and the level held in the capacitive element 322 for each frame.

The solid-state imaging element 200 according to the seventh embodiment continuously images a plurality of frames in synchronization with a vertical synchronization signal in a mode other than a sensing mode (such as a normal imaging mode). An odd-numbered frame is referred to as “odd frame”, and an even-numbered frame is referred to as “even frame”. Note that the odd frame and the even frame are an example of a pair of frames recited in the claims.

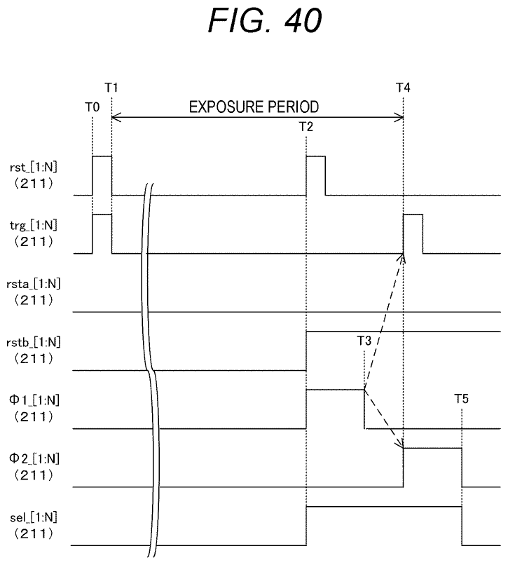

FIG. 40 is a timing chart illustrating an example of the global shutter operation of the odd frame in the seventh embodiment. The drawing illustrates control other than the sensing mode. The pre-stage circuit 310 in the solid-state imaging element 200 sets the selection signal Φ2 to the high level next to the selection signal Φ1 within the exposure period of the odd frame, thereby causing the capacitive element 321 to hold the reset level, and then causing the capacitive element 322 to hold the signal level.

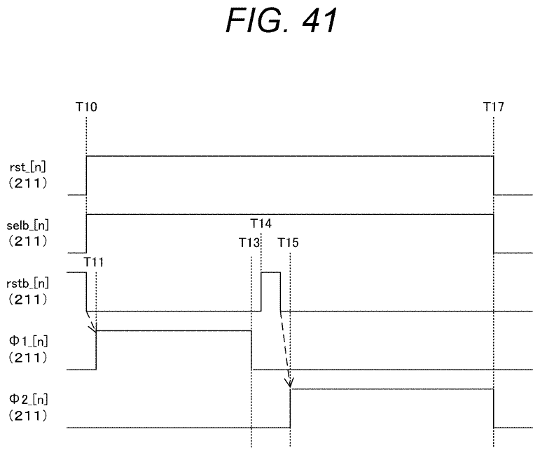

FIG. 41 is a timing chart illustrating an example of the reading operation of the odd frame according to the seventh embodiment of the present technology. The post-stage circuit 350 in the solid-state imaging element 200 sets the selection signal Φ2 to the high level next to the selection signal Φ1 and reads the signal level next to the reset level within the reading period of the odd frame.

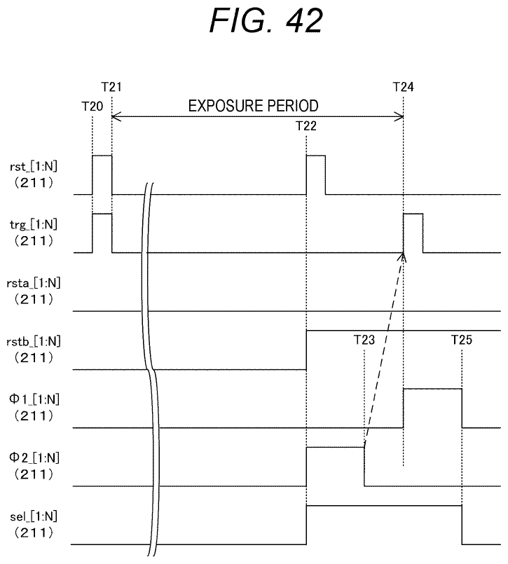

FIG. 42 is a timing chart illustrating an example of the global shutter operation for the even frame in the seventh embodiment. The pre-stage circuit 310 in the solid-state imaging element 200 sets the selection signal Φ1 next to the selection signal Φ2 to the high level within the exposure period of the even frame, thereby causing the capacitive element 322 to hold the reset level, and then causing the capacitive element 321 to hold the signal level.

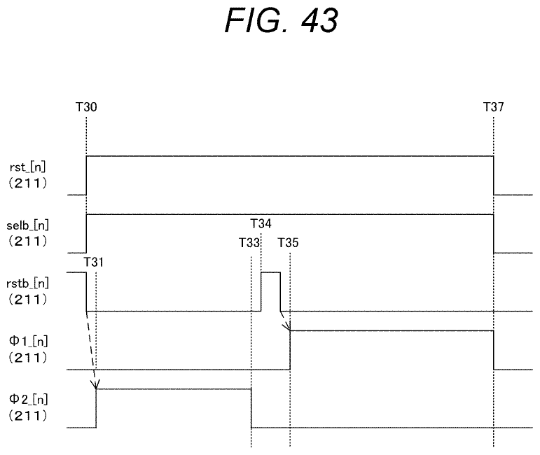

FIG. 43 is a timing chart illustrating an example of a reading operation for the even frame according to the seventh embodiment of the present technology. The post-stage circuit 350 in the solid-state imaging element 200 sets the selection signal Φ1 to the high level next to the selection signal Φ2 and reads the signal level next to the reset level within the reading period of the even frame.

As illustrated in FIGS. 40 and 42, the levels held in the capacitive elements 321 and 322 are reversed between the even frame and the odd frame. This also reverses the polarity of PRNU between the even frame and the odd frame. The column signal processing circuit 260 in the subsequent stage obtains the average of the odd frame and the even frame. It is therefore possible to cancel out PRNU with opposite polarities.

This control is effective in capturing a moving image or adding up frames. Furthermore, it is not necessary to add an element to the pixel 300, and it can be realized only by changing a driving system.

Note that the first to third modifications of the fourth embodiment, and the fifth and sixth embodiments can also be applied to the seventh embodiment.

As described above, in the seventh embodiment of the present technology, the level held in the capacitive element 321 and the level held in the capacitive element 322 are reversed between the odd frame and the even frame in modes other than the sensing mode. Therefore, the polarity of the PRNU can be reversed between the odd frame and the even frame. The column signal processing circuit 260 adds up the odd frame and the even frame, so that it is possible to suppress deterioration of PRNU.

### 8. Eighth Embodiment

In the above-described fourth embodiment, the vertical scanning circuit 211 performs control (that is, global shutter operation) to simultaneously expose all rows (all pixels). In a case where the simultaneity of exposure is not required, but low noise is required, such as at the time of test or analysis, it is, however, desirable to perform a rolling shutter operation. A solid-state imaging element 200 of the eighth embodiment is different from that of the fourth embodiment in that a rolling shutter operation is performed at the time of a test or the like.

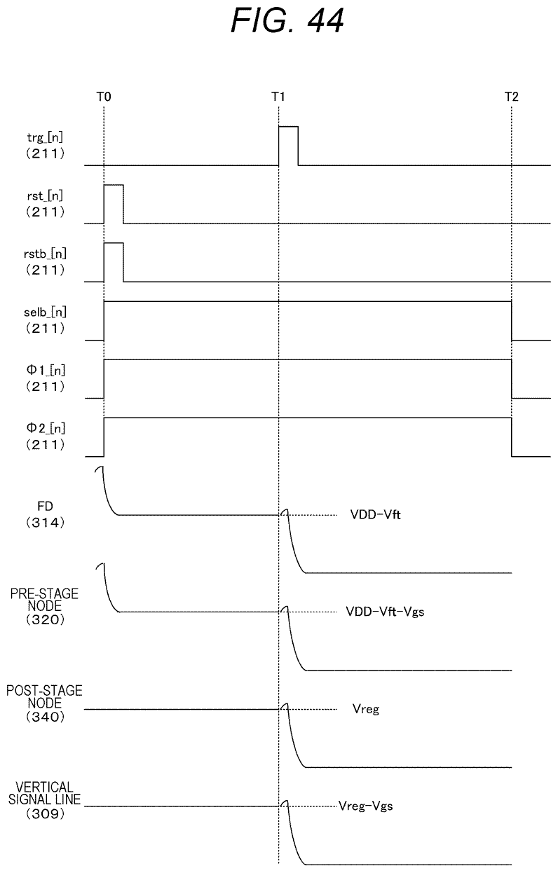

FIG. 44 is a timing chart illustrating an example of a rolling shutter operation according to the eighth embodiment of the present technology. The vertical scanning circuit 211 performs control to sequentially select a plurality of rows and start exposure. This drawing illustrates exposure control of the n-th row.

During a period from timing T0 to T2, a vertical scanning circuit 211 supplies a high-level post-stage selection signal selb, a selection signal Φ1, and a selection signal Φ2 to the n-th row. Furthermore, at timing T0 that is the start of exposure, the vertical scanning circuit 211 supplies the high-level FD reset signal rst and the high-level post-stage reset signal rstb to the n-th row over the pulse period. At timing T1 that is the end of exposure, the vertical scanning circuit 211 supplies the transfer signal trg to the n-th row. The rolling shutter operation in the drawing allows the solid-state imaging element 200 to generate low-noise image data.

Note that the solid-state imaging element 200 of the eighth embodiment performs the global shutter operation similarly to the fourth embodiment except for the time of the test.

Furthermore, the first to third modifications of the fourth embodiment, and the fifth to seventh embodiments can also be applied to the eighth embodiment.

As described above, according to the eighth embodiment of the present technology, the vertical scanning circuit 211 performs control (that is, rolling shutter operation) to sequentially select a plurality of rows and start exposure, and thus, it is possible to generate low-noise image data.

### 9. Ninth Embodiment

In the above-described fourth embodiment, a source of a pre-stage source follower (the pre-stage amplification transistor 315 and the current source transistor 316) is connected to the power supply voltage VDD, and reading is performed row by row in a state where the source follower is turned on. There is, however, a possibility that this driving method causes circuit noise of the pre-stage source follower at the time of row-by-row reading to propagate to the subsequent stages, and random noise increases accordingly. A solid-state imaging element 200 of the ninth embodiment is different from that of the fourth embodiment in that noise is reduced by turning off the pre-stage source follower at the time of reading.

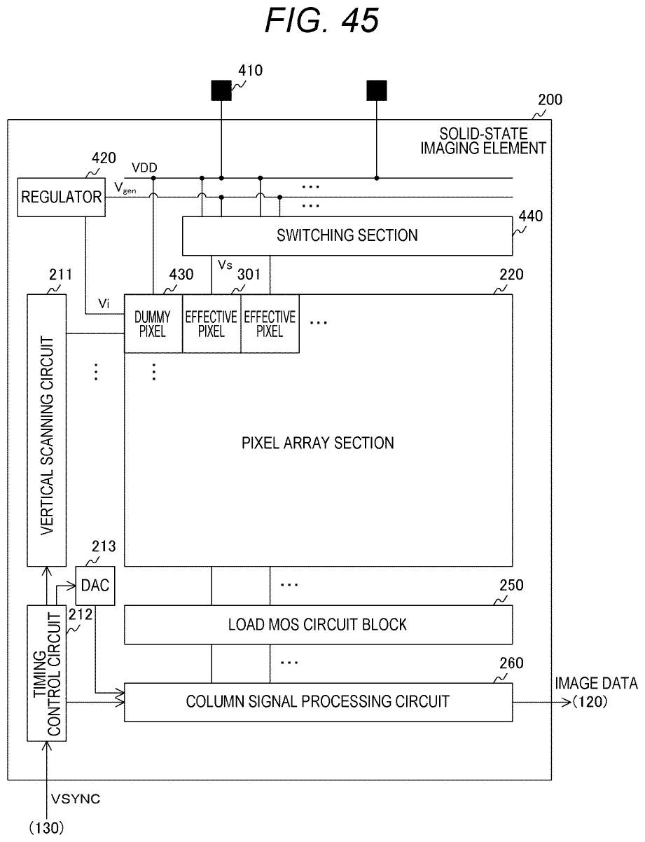

FIG. 45 is a block diagram illustrating a configuration example of the solid-state imaging element 200 according to the ninth embodiment of the present technology. The solid-state imaging element 200 of the ninth embodiment is different from that of the fourth embodiment in further including a regulator 420 and a switching section 440. Furthermore, in a pixel array section 220 of the ninth embodiment, a plurality of effective pixels 301 and a predetermined number of dummy pixels 430 are arranged. The dummy pixels 430 are arranged around a region where the effective pixels 301 are arranged.

Furthermore, the power supply voltage VDD is supplied to each of the dummy pixels 430, and the power supply voltage VDD and a source voltage Vs are supplied to each of the effective pixels 301. The signal lines for supplying the power supply voltage VDD to the effective pixels 301 are not illustrated in the drawing. Furthermore, the power supply voltage VDD is supplied from a pad 410 located outside the solid-state imaging element 200.

The regulator 420 generates a constant generation voltage V_{gen} on the basis of an input voltage Vi from the dummy pixel 430 and supplies the generation voltage V_{gen} to the switching section 440. The switching section 440 selects either the power supply voltage VDD from the pad 410 or the generation voltage V_{gen} from the regulator 420, and supplies the selected voltage as the source voltage Vs to each of the columns of the effective pixels 301.

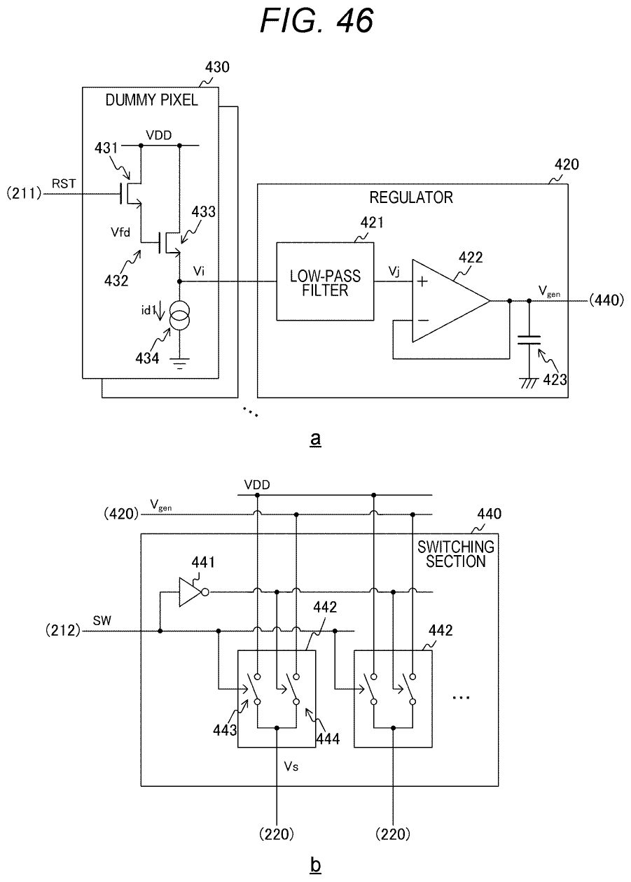

FIG. 46 is a circuit diagram illustrating a configuration example of the dummy pixel 430, the regulator 420, and the switching section 440 according to the ninth embodiment of the present technology. Of the drawing, a indicates a circuit diagram of the dummy pixel 430 and the regulator 420, and b of the drawing indicates a circuit diagram of the switching section 440.

As illustrated in a of the drawing, the dummy pixel 430 includes a reset transistor 431, an FD 432, an amplification transistor 433, and a current source transistor 434. The reset transistor 431 initializes the FD 432 in accordance with a reset signal RST from the vertical scanning circuit 211. The FD 432 accumulates charges, and generates a voltage according to a charge amount. The amplification transistor 433 amplifies a level of a voltage of the FD 432 and supplies the amplified voltage as the input voltage Vi to the regulator 420.

Furthermore, the FD reset transistor 431 and the amplification transistor 433 have their respective sources connected to the power supply voltage VDD. The current source transistor 434 is connected to a drain of the amplification transistor 433. The current source transistor 434 supplies the current id1 under the control of the vertical scanning circuit 211.

The regulator 420 includes a low-pass filter 421, a buffer amplifier 422, and a capacitive element 423. The low-pass filter 421 passes, as an output voltage Vj, a component in a low-frequency band below a predetermined frequency out of a signal of the input voltage Vi.

The output voltage Vj is input to a non-inverting input terminal (+) of the buffer amplifier 422. An inverting input terminal (−) of the buffer amplifier 422 is connected to an output terminal thereof. The capacitor element 423 holds a voltage of the output terminal of the buffer amplifier 422 as V_{gen}. This V_{gen} is supplied to the switching section 440.

As illustrated in b of the drawing, the switching section 440 includes an inverter 441 and a plurality of switching circuits 442. The switching circuits 442 are each disposed for a corresponding one of the columns of the effective pixels 301.

The inverter 441 inverts a switching signal SW sent from the timing control circuit 212. The inverter 441 supplies the inverted signal to each of the switching circuits 442.

The switching circuit 442 selects either the power supply voltage VDD or the generation voltage V_{gen} and supplies the selected voltage as the source voltage Vs to the corresponding column in the pixel array section 220. The switching circuits 442 each include switches 443 and 444. The switch 443 opens and closes a path between the node of the power supply voltage VDD and the corresponding column, in accordance with the switching signal SW. The switch 444 opens and closes a path between the node of the generation voltage V_{gen} and the corresponding column in accordance with the inverted signal of the switching signal SW.

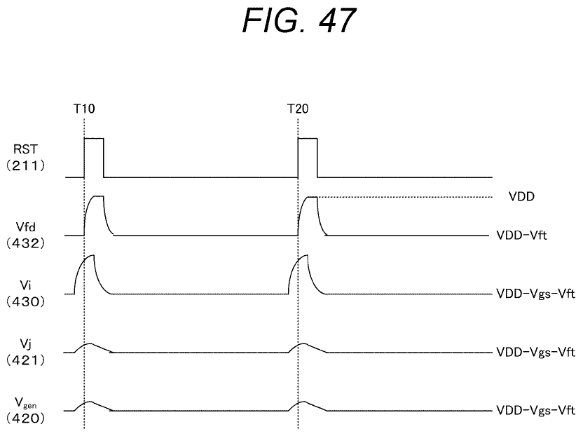

FIG. 47 is a timing chart illustrating an example of an operation of the dummy pixel 430 and the regulator 420 according to the ninth embodiment of the present technology. At timing T10 immediately before reading of a certain row, the vertical scanning circuit 211 supplies a high-level reset signal RST (here, the power supply voltage VDD) to each of the dummy pixels 430. A potential Vfd of the FD 432 in the dummy pixel 430 is initialized to the power supply voltage VDD. Then, when the reset signal RST becomes the low level, reset feedthrough causes a change to VDD−Vft.

Furthermore, the input voltage Vi decreases to VDD−Vgs−Vsig after the reset. By passing through the low-pass filter 421, Vj and V_{gen} become approximately constant voltages.

After timing T20 immediately before reading of the next row, similar control is performed for each row, and the constant generation voltage V_{gen} is supplied.

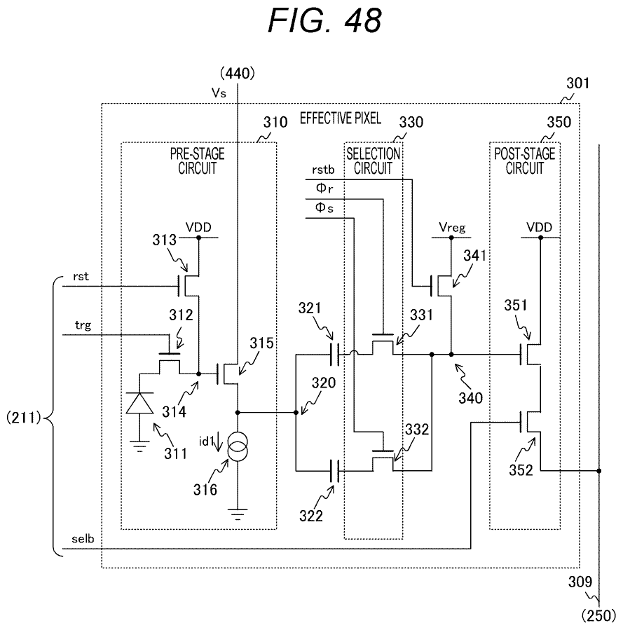

FIG. 48 is a circuit diagram illustrating a configuration example of the effective pixel 301 according to the ninth embodiment of the present technology. The circuit configuration of the effective pixel 301 is similar to that of the pixel 300 of the fourth embodiment except that the source voltage Vs from the switching section 440 is supplied to the source of the pre-stage amplification transistor 315.

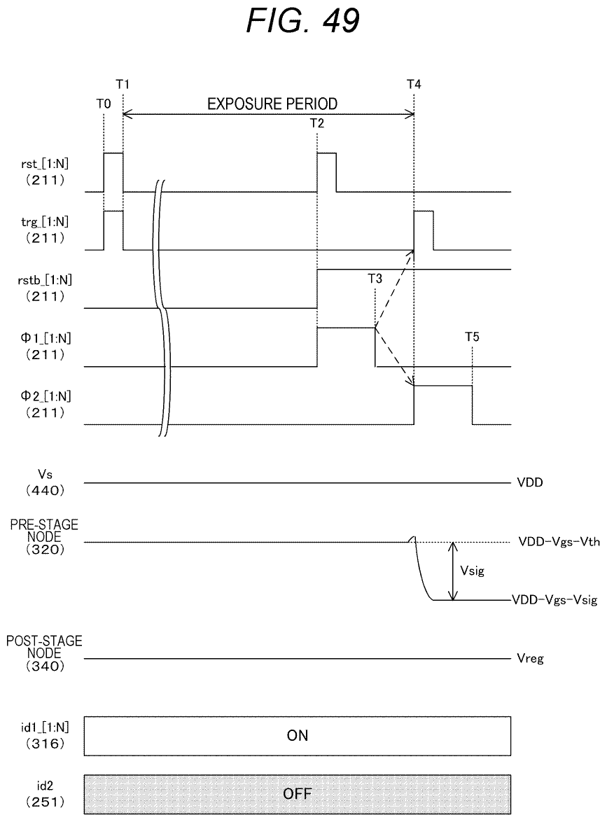

FIG. 49 is a timing chart illustrating an example of a global shutter operation according to the ninth embodiment of the present technology. In the ninth embodiment, when exposure is performed simultaneously in all the pixels, the switching section 440 selects the power supply voltage VDD and supplies the power supply voltage VDD as the source voltage Vs. Furthermore, the voltage of the pre-stage node decreases from VDD−Vgs−Vth to VDD−Vgs−Vsig at timing T4. Here, Vth represents a threshold voltage of the transfer transistor 312.

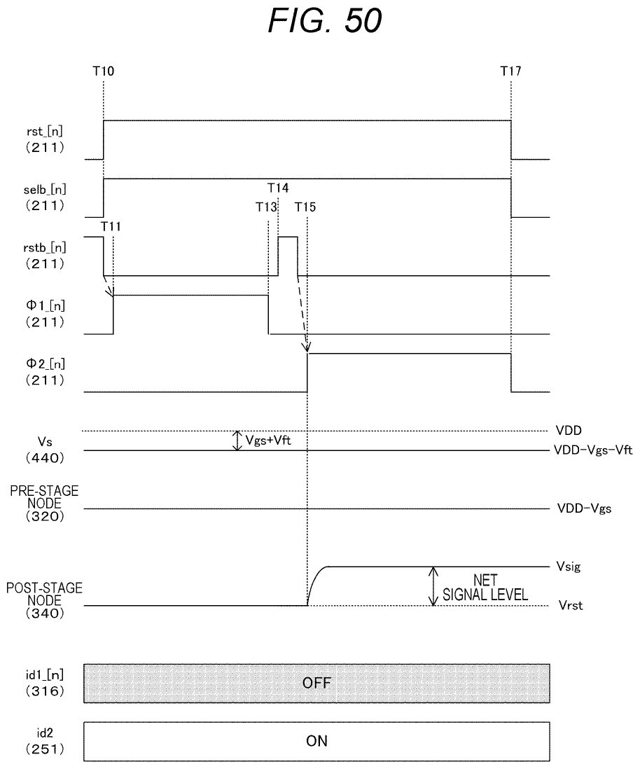

FIG. 50 is a timing chart illustrating an example of a reading operation according to the ninth embodiment of the present technology. The drawing illustrates control other than the sensing mode. In the ninth embodiment, at the time of reading, the switching section 440 selects the generation voltage V_{gen} and supplies the generation voltage V_{gen} as the source voltage Vs. The generation voltage V_{gen} is adjusted to VDD−Vgs−Vft. Furthermore, in the ninth embodiment, the vertical scanning circuit 211 controls the current source transistors 316 of all rows (all pixels) to stop the supply of the current id1.

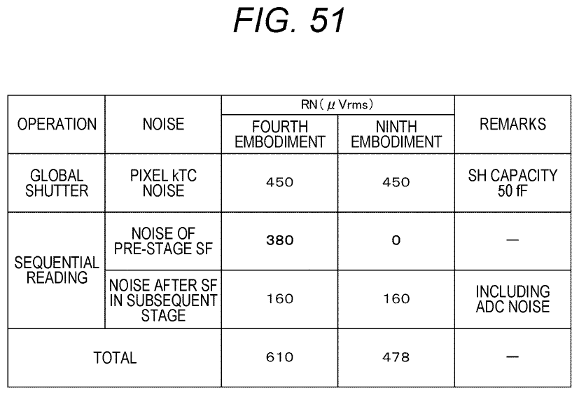

FIG. 51 is a diagram for explaining an effect in the ninth embodiment of the present technology. In the fourth embodiment, the source follower (the pre-stage amplification transistor 315 and the current source transistor 316) of the pixel 300 to be read is turned on during row-by-row reading. There is, however, a possibility that this driving method causes circuit noise of the pre-stage source follower to propagate to the subsequent stages (capacitive element, and post-stage source follower and ADC), and readout noise increases accordingly.

For example, in the fourth embodiment, as illustrated in the drawing, kTC noise generated in a pixel during a global shutter operation is 450 (μVrms). Furthermore, noise generated in the pre-stage source follower (the pre-stage amplification transistor 315 and the current source transistor 316) during the row-by-row reading is 380 (μVrms). Noise generated after the source follower in the subsequent stage is 160 (μVrms). Therefore, the total noise is 610 (μVrms). As described above, in the fourth embodiment, the contribution of the noise of the pre-stage source follower in the total value of the noise becomes relatively large.

In order to reduce the noise of the pre-stage source follower, in the ninth embodiment, as described above, the voltage (Vs) that can be adjusted is supplied to the source of the pre-stage source follower. During the global shutter (exposure) operation, the switching section 440 selects the power supply voltage VDD and supplies the selected power supply voltage as the source voltage Vs. Then, after the end of exposure, the switching section 440 switches the source voltage Vs to VDD−Vgs−Vft. Furthermore, the timing control circuit 212 turns on the pre-stage current source transistor 316 during the global shutter (exposure) operation, and turns off the pre-stage current source transistor 316 after the end of exposure.

With the above-described control, as illustrated in FIGS. 49 and 50, the potentials of the pre-stage nodes at the time of the global shutter operation and at the time of reading for each row are aligned, and the PRNU can be improved. Furthermore, since the pre-stage source follower is turned off at the time of reading for each row, circuit noise of the source follower does not occur and becomes zero (μVrms) as illustrated in FIG. 51. Note that, in the pre-stage source follower, the pre-stage amplification transistor 315 is in the on state.

As described above, according to the ninth embodiment of the present technology, since the pre-stage source follower is turned off at the time of reading, noise generated in the source follower can be reduced.

### 10. Application Example to Moving Body

The technology (the present technology) according to the present disclosure can be applied to various products. For example, the technology of the present disclosure may be achieved in the form of a device to be mounted on a moving body of any kind, such as an automobile, an electric vehicle, a hybrid electric vehicle, a motorcycle, a bicycle, a personal mobility, an airplane, a drone, a vessel, or a robot.

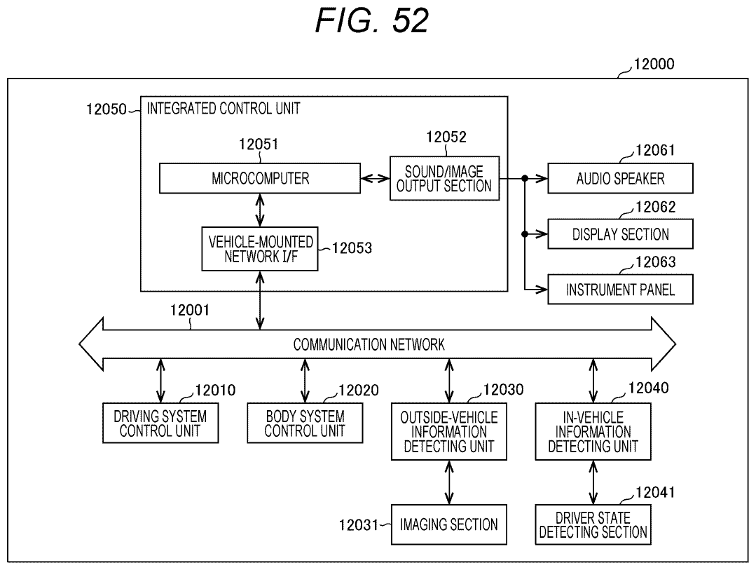

FIG. 52 is a block diagram illustrating a schematic configuration example of a vehicle control system which is an example of a mobile object control system to which the technology according to the present disclosure can be applied.

The vehicle control system 12000 includes a plurality of electronic control units connected to each other via a communication network 12001. In the example illustrated in FIG. 52, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 52, an audio speaker 12061, a display section 12062, and an instrument panel 12063 are illustrated as the output device. The display section 12062 may, for example, include at least one of an on-board display and a head-up display.

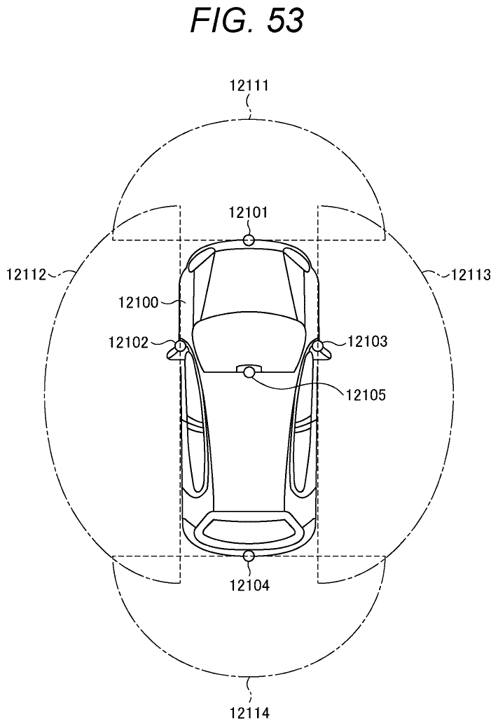

FIG. 53 is a diagram illustrating an example of an installation position of the imaging section 12031.

In FIG. 53, imaging sections 12101, 12102, 12103, 12104, and 12105 are included as the imaging section 12031.

The imaging sections 12101, 12102, 12103, 12104, 12105 are provided, for example, at positions such as a front nose, a sideview mirror, a rear bumper, a back door, and an upper portion of a windshield in the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 53 illustrates examples of photographing ranges of the image capturing sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure may be applied to the imaging section 12031 in the configuration described above. Specifically, for example, the imaging device 100 in FIG. 1 can be applied to the imaging section 12031. By applying the technology according to the present disclosure to the imaging section 12031, the system can be simplified.

Note that the embodiments described above show examples for embodying the present technology, and the matters in the embodiments and the matters specifying the invention in the claims have correspondence relationships. Similarly, the matters specifying the invention in the claims and matters with the same names in the embodiments of the present technology have correspondence relationships. However, the present technology is not limited to the embodiments, and can be embodied by applying various modifications to the embodiments without departing from the scope of the present technology.

Note that advantageous effects described in the present description are merely examples and are not limited, and other advantageous effects may be provided.

Note that the present technology may also have the following configurations.

(1) A solid-state imaging element including:
a pixel including a pre-stage circuit that sequentially generates a predetermined number of pixel signals and a pair of capacitive elements;
a scanning circuit that causes the pair of capacitive elements to hold respective signal levels of a pair of pixel signals among the predetermined number of pixel signals in a case where a sensing mode is set, and causes the pair of capacitive elements to hold a reset level and a signal level of any of the predetermined number of pixel signals in a case where the sensing mode is switched to a normal imaging mode;
a difference calculation circuit that calculates a difference between the respective signal levels of the pair of pixel signals in a case where the sensing mode is set; and
a mode control section that determines whether or not to switch from the sensing mode to the normal imaging mode on the basis of the difference.

(2) The solid-state imaging element according to (1) described above, in which
the mode control section determines whether or not to switch from the sensing mode to the normal imaging mode on the basis of a comparison result between an absolute value of the difference and a predetermined threshold.

(3) The solid-state imaging element according to (2) described above, further including
a focus control section that detects an in-focus position of a lens and moves the lens to the in-focus position,
in which the difference calculation circuit calculates a difference between a signal level before the lens moves to the in-focus position and a signal level when the lens has moved to the in-focus position, and
the mode control section determines whether or not to switch from the sensing mode to the normal imaging mode on the basis of a comparison result between an absolute value of the difference and a predetermined threshold when the lens has moved to the in-focus position.

(4) The solid-state imaging element according to any one of (1) to (3) described above, in which
the pre-stage circuit includes:
a photoelectric conversion element;
a transfer transistor that transfers a charge from the photoelectric conversion element to a floating diffusion layer; and
a pre-stage amplification transistor that amplifies a voltage of the floating diffusion layer.

(5) The solid-state imaging element according to (4) described above, in which
the scanning circuit causes one of the pair of capacitive elements to hold a first signal level at an end of odd-numbered exposure and causes another of the pair of capacitive elements to hold a second signal level at an end of even-numbered exposure in a case where the sensing mode is set, and causes the pair of capacitive elements to hold a reset level and a signal level at an end of exposure in a case of being switched to the normal imaging mode.

(6) The solid-state imaging element according to (4) described above, in which
the scanning circuit causes one of the pair of capacitive elements to hold a first signal level at an end of odd-numbered exposure and causes another of the pair of capacitive elements to hold a second signal level at an end of even-numbered exposure in a case where the sensing mode is set, and causes one of the pair of capacitive elements to hold a reset level at an end of exposure in a case of being switched to the normal imaging mode.

(7) The solid-state imaging element according to (1) described above, in which
the pre-stage circuit includes:
first and second photoelectric conversion elements;
a first transfer transistor that transfers a charge from the first photoelectric conversion element to a floating diffusion layer;
a second transfer transistor that transfers a charge from the second photoelectric conversion element to the floating diffusion layer; and
a pre-stage amplification transistor that amplifies a voltage of the floating diffusion layer, and
the first and second photoelectric conversion elements have exposure periods partially overlapping with each other.

(8) The solid-state imaging element according to (7) described above, in which
the scanning circuit causes one of the pair of capacitive elements to hold a first signal level according to an exposure amount of the first photoelectric conversion element and causes another of the pair of capacitive elements to hold a second signal level according to an exposure amount of the second photoelectric conversion element in a case where the sensing mode is set, and causes the pair of capacitive elements to hold a reset level and a signal level at an end of exposure in a case of being switched to the normal imaging mode.

(9) The solid-state imaging element according to (1) described above, in which
the pre-stage circuit includes:
a photoelectric conversion element;
a first transfer transistor that transfers a charge from the photoelectric conversion element to one of the pair of capacitive elements;
a second transfer transistor that transfers a charge from the photoelectric conversion element to another of the pair of capacitive elements; and
a discharge transistor that discharges a charge from the photoelectric conversion element.

(10) The solid-state imaging element according to (1) described above, in which
the pixel further includes:
a selection circuit that sequentially performs control to connect one of the pair of capacitive elements to a predetermined post-stage node, control to disconnect both the pair of capacitive elements from the post-stage node, and control to connect another of the pair of capacitive elements to the post-stage node;
a post-stage reset transistor that initializes a level of the post-stage node when both the pair of capacitive elements are disconnected from the post-stage node; and
a post-stage circuit that reads the pixel signals from the pair of capacitive elements via the post-stage node and outputs the pixel signals.

(11) An imaging device including:
a pixel including a pre-stage circuit that sequentially generates a predetermined number of pixel signals and a pair of capacitive elements;
a scanning circuit that causes the pair of capacitive elements to hold respective signal levels of a pair of pixel signals among the predetermined number of pixel signals in a case where a sensing mode is set, and causes the pair of capacitive elements to hold a reset level and a signal level of any of the predetermined number of pixel signals in a case where the sensing mode is switched to a normal imaging mode;
a difference calculation circuit that calculates a difference between the respective signal levels of the pair of pixel signals in a case where the sensing mode is set;
a mode control section that determines whether or not to switch from the sensing mode to the normal imaging mode on the basis of the difference; and
an image data processing section that processes image data in which differences between the reset level and the signal level are arranged in a case of being switched to the normal imaging mode.

(12) A method of controlling a solid-state imaging element including a pixel including a pre-stage circuit that sequentially generates a predetermined number of pixel signals and a pair of capacitive elements, the method including:
a scanning procedure of causing the pair of capacitive elements within the pixel to hold respective signal levels of a pair of pixel signals among the predetermined number of pixel signals in a case where a sensing mode is set, and causing the pair of capacitive elements to hold a reset level and a signal level of any of the predetermined number of pixel signals in a case where the sensing mode is switched to a normal imaging mode;
a difference calculation procedure of calculating a difference between the respective signal levels of the pair of pixel signals in a case where the sensing mode is set; and
a mode control procedure of determining whether or not to switch from the sensing mode to the normal imaging mode on the basis of the difference.

### REFERENCE SIGNS LIST

100 Imaging device
110 Optical section
120 Recording section
130 Imaging control section
200 Solid-state imaging element
201 Pixel chip
202 Circuit chip
203 Upper pixel chip
204 Lower pixel chip
211 Vertical scanning circuit
212 Timing control circuit
213 DAC
220 Pixel array section
221 Upper pixel array section
222 Lower pixel array section
250 Load MOS circuit block
251 Load MOS transistor
260 Column signal processing circuit
261 ADC
262 Digital signal processing section
263 Difference calculation circuit
264 Mode control section
265 Image data processing section
266 Focus control section
300 Pixel
301 Effective pixel
305 Phase difference pixel
310 Pre-stage circuit
311, 311-1, 311-2 Photoelectric conversion element
312, 312-1, 312-2 Transfer transistor
313 FD reset transistor
314, 432 FD
315 Pre-stage amplification transistor
316, 434 Current source transistor
317 Discharge transistor
321, 322, 423 Capacitive element
323 Pre-stage reset transistor
324 Pre-stage selection transistor
330 Selection circuit
331, 332 Selection transistor
341 Post-stage reset transistor
350, 350-1, 350-2 Post-stage circuit
351, 351-1, 351-2 Post-stage amplification transistor
352, 352-1, 352-2 Post-stage selection transistor
420 Regulator
421 Low-pass filter
422 Buffer amplifier
430 Dummy pixel
431 Reset transistor
433 Amplification transistor
440 Switching section
441 Inverter
442 Switching circuit
443, 444 Switch
12031 Imaging section

1. A solid-state imaging element comprising:
a pixel including a pre-stage circuit that sequentially generates a predetermined number of pixel signals and a pair of capacitive elements;
a scanning circuit that causes the pair of capacitive elements to hold respective signal levels of a pair of pixel signals among the predetermined number of pixel signals in a case where a sensing mode is set, and causes the pair of capacitive elements to hold a reset level and a signal level of any of the predetermined number of pixel signals in a case where the sensing mode is switched to a normal imaging mode;
a difference calculation circuit that calculates a difference between the respective signal levels of the pair of pixel signals in a case where the sensing mode is set; and
a mode control section that determines whether or not to switch from the sensing mode to the normal imaging mode on a basis of the difference.

2. The solid-state imaging element according to claim 1, wherein
the mode control section determines whether or not to switch from the sensing mode to the normal imaging mode on a basis of a comparison result between an absolute value of the difference and a predetermined threshold.

3. The solid-state imaging element according to claim 2, further comprising
a focus control section that detects an in-focus position of a lens and moves the lens to the in-focus position,
wherein the difference calculation circuit calculates a difference between a signal level before the lens moves to the in-focus position and a signal level when the lens has moved to the in-focus position, and
the mode control section determines whether or not to switch from the sensing mode to the normal imaging mode on a basis of a comparison result between an absolute value of the difference and a predetermined threshold when the lens has moved to the in-focus position.

4. The solid-state imaging element according to claim 1, wherein
the pre-stage circuit includes:
a photoelectric conversion element;
a transfer transistor that transfers a charge from the photoelectric conversion element to a floating diffusion layer; and
a pre-stage amplification transistor that amplifies a voltage of the floating diffusion layer.

5. The solid-state imaging element according to claim 4, wherein
the scanning circuit causes one of the pair of capacitive elements to hold a first signal level at an end of odd-numbered exposure and causes another of the pair of capacitive elements to hold a second signal level at an end of even-numbered exposure in a case where the sensing mode is set, and causes the pair of capacitive elements to hold a reset level and a signal level at an end of exposure in a case of being switched to the normal imaging mode.

6. The solid-state imaging element according to claim 4, wherein
the scanning circuit causes one of the pair of capacitive elements to hold a first signal level at an end of odd-numbered exposure and causes another of the pair of capacitive elements to hold a second signal level at an end of even-numbered exposure in a case where the sensing mode is set, and causes one of the pair of capacitive elements to hold a reset level at an end of exposure in a case of being switched to the normal imaging mode.

7. The solid-state imaging element according to claim 1, wherein
the pre-stage circuit includes:
first and second photoelectric conversion elements;
a first transfer transistor that transfers a charge from the first photoelectric conversion element to a floating diffusion layer;
a second transfer transistor that transfers a charge from the second photoelectric conversion element to the floating diffusion layer; and
a pre-stage amplification transistor that amplifies a voltage of the floating diffusion layer, and
the first and second photoelectric conversion elements have exposure periods partially overlapping with each other.

8. The solid-state imaging element according to claim 7, wherein
the scanning circuit causes one of the pair of capacitive elements to hold a first signal level according to an exposure amount of the first photoelectric conversion element and causes another of the pair of capacitive elements to hold a second signal level according to an exposure amount of the second photoelectric conversion element in a case where the sensing mode is set, and causes the pair of capacitive elements to hold a reset level and a signal level at an end of exposure in a case of being switched to the normal imaging mode.

9. The solid-state imaging element according to claim 1, wherein
the pre-stage circuit includes:
a photoelectric conversion element;
a first transfer transistor that transfers a charge from the photoelectric conversion element to one of the pair of capacitive elements;
a second transfer transistor that transfers a charge from the photoelectric conversion element to another of the pair of capacitive elements; and
a discharge transistor that discharges a charge from the photoelectric conversion element.

10. The solid-state imaging element according to claim 1, wherein
the pixel further includes:
a selection circuit that sequentially performs control to connect one of the pair of capacitive elements to a predetermined post-stage node, control to disconnect both the pair of capacitive elements from the post-stage node, and control to connect another of the pair of capacitive elements to the post-stage node;
a post-stage reset transistor that initializes a level of the post-stage node when both the pair of capacitive elements are disconnected from the post-stage node; and
a post-stage circuit that reads the pixel signals from the pair of capacitive elements via the post-stage node and outputs the pixel signals.

11. An imaging device comprising:
a pixel including a pre-stage circuit that sequentially generates a predetermined number of pixel signals and a pair of capacitive elements;
a scanning circuit that causes the pair of capacitive elements to hold respective signal levels of a pair of pixel signals among the predetermined number of pixel signals in a case where a sensing mode is set, and causes the pair of capacitive elements to hold a reset level and a signal level of any of the predetermined number of pixel signals in a case where the sensing mode is switched to a normal imaging mode;
a difference calculation circuit that calculates a difference between the respective signal levels of the pair of pixel signals in a case where the sensing mode is set;
a mode control section that determines whether or not to switch from the sensing mode to the normal imaging mode on a basis of the difference; and
an image data processing section that processes image data in which differences between the reset level and the signal level are arranged in a case of being switched to the normal imaging mode.

12. A method of controlling a solid-state imaging element including a pixel including a pre-stage circuit that sequentially generates a predetermined number of pixel signals and a pair of capacitive elements, the method comprising:
a scanning procedure of causing the pair of capacitive elements within the pixel to hold respective signal levels of a pair of pixel signals among the predetermined number of pixel signals in a case where a sensing mode is set, and causing the pair of capacitive elements to hold a reset level and a signal level of any of the predetermined number of pixel signals in a case where the sensing mode is switched to a normal imaging mode;
a difference calculation procedure of calculating a difference between the respective signal levels of the pair of pixel signals in a case where the sensing mode is set; and
a mode control procedure of determining whether or not to switch from the sensing mode to the normal imaging mode on a basis of the difference.
